(19) United States
(12) Patent Application Publication
(10) Pub. No.: US 2023/0216612 A1
(43) Pub. Date: Jul. 6, 2023

(54) ENHANCED FEEDBACK TRANSMISSION FOR SIDELINK COMMUNICATION IN UNLICENSED SPECTRUM

(71) Applicant: QUALCOMM Incorporated, San Diego, CA (US)

(72) Inventors: Shuanshuan WU, San Diego, CA (US); Arthur GUBESKYS, San Diego, CA (US); Parisa CHERAGHI, Cambridge (GB); Stelios STEFANATOS, San Diego, CA (US); Gabi SARKIS, San Diego, CA (US)

(21) Appl. No.: 18/000,523

(22) PCT Filed: Jul. 26, 2021
(86) PCT No.: PCT/US2021/043211

§ 371 Date: Dec. 2, 2022

(30) Foreign Application Priority Data
Jul. 31, 2020 (GR) 20200100454

(51) Int. Cl. H04L 1/1812; H04W 72/54; H04L 5/00; H04W 72/02

(52) U.S. Cl. CPC H04L 1/1812; H04W 72/54; H04L 5/0053; H04W 72/02

(57) ABSTRACT

Certain aspects of the present disclosure provide techniques for enhanced feedback transmission for sidelink communication in unlicensed spectrum. A method that may be performed by a first user equipment (UE) includes receiving a sidelink transmission in a frequency band from a second UE; and transmitting feedback comprising: hybrid automatic retransmission request (HARQ) feedback regarding the sidelink transmission, and an indication of a measure of an energy level of the frequency band as measured by the first UE

### CROSS-REFERENCE TO RELATED APPLICATION

This application claims benefit of and priority to Greece Patent Application No. 20200100454, filed Jul. 31, 2020, which is herein incorporated by reference in its entirety for all applicable purposes.

### INTRODUCTION

Aspects of the present disclosure relate to wireless communications, and more particularly, to techniques for sidelink communication.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide sidelink communications with interference avoidance feedback.

Certain aspects of the subject matter described in this disclosure can be implemented in a method for wireless communication by a first user equipment (UE). The method generally includes receiving a sidelink transmission in a frequency band from a second UE; and transmitting feedback comprising: hybrid automatic retransmission request (HARQ) feedback regarding the sidelink transmission, and an indication of a measure of an energy level of the frequency band as measured by the first UE.

Certain aspects of the subject matter described in this disclosure can be implemented in a method for wireless communication by a second UE. The method generally includes transmitting a sidelink transmission in a frequency band to a first UE; and receiving feedback comprising: HARQ feedback regarding the sidelink transmission, and an indication of a measure of an energy level of the frequency band as measured by the second UE.

Certain aspects of the subject matter described in this disclosure can be implemented in an apparatus for wireless communication. The apparatus generally includes a memory and a processor, which is coupled to the memory. The processor and the memory are configured to receive a sidelink transmission in a frequency band from a user equipment, transmit feedback comprising: HARQ feedback regarding the sidelink transmission, and an indication of a measure of an energy level of the frequency band as measured by the apparatus.

Certain aspects of the subject matter described in this disclosure can be implemented in an apparatus for wireless communication. The apparatus generally includes a memory and a processor, which is coupled to the memory. The processor and the memory are configured to transmit a sidelink transmission in a frequency band to a user equipment, and receive feedback comprising: HARQ feedback regarding the sidelink transmission, and an indication of a measure of an energy level of the frequency band as measured by the user equipment.

Certain aspects of the subject matter described in this disclosure can be implemented in an apparatus for wireless communication. The apparatus generally includes means for receiving a sidelink transmission in a frequency band from a UE; and means for transmitting feedback comprising: HARQ feedback regarding the sidelink transmission, and an indication of a measure of an energy level of the frequency band as measured by the apparatus.

Certain aspects of the subject matter described in this disclosure can be implemented in an apparatus for wireless communication. The apparatus generally includes means for transmitting a sidelink transmission in a frequency band to a UE; and means for receiving feedback comprising: HARQ feedback regarding the sidelink transmission, and an indication of a measure of an energy level of the frequency band as measured by the apparatus.

Certain aspects of the subject matter described in this disclosure can be implemented in a computer-readable medium for wireless communication. The computer-readable medium includes instructions that, when executed by a processing system, cause the processing system to perform operations generally including receiving a sidelink transmission in a frequency band from a second UE; and transmitting feedback comprising: HARQ feedback regarding the sidelink transmission, and an indication of a measure of an energy level of the frequency band as measured by a first UE.

Certain aspects of the subject matter described in this disclosure can be implemented in a computer-readable medium for wireless communication. The computer-readable medium includes instructions that, when executed by a processing system, cause the processing system to perform operations generally including transmitting a sidelink transmission in a frequency band to a first UE; and receiving feedback comprising: HARQ feedback regarding the sidelink transmission, and an indication of a measure of an energy level of the frequency band as measured by the second UE.

Certain aspects of the subject matter described in this disclosure can be implemented in a method for wireless communication by a first user equipment (UE). The method generally includes attempting to decode a first sidelink transmission received in a frequency band from a second UE; and transmitting joint feedback comprising hybrid automatic retransmission request (HARQ) feedback regarding the first sidelink transmission and an indication of a measure of an energy level of the frequency band as measured by the first UE.

Certain aspects of the subject matter described in this disclosure can be implemented in a method for wireless communication by a first user equipment (UE). The method generally includes transmitting a first sidelink transmission in a frequency band to a second UE; and receiving joint feedback comprising hybrid automatic retransmission request (HARQ) feedback regarding the first sidelink transmission and an indication of a measure of an energy level of the frequency band as measured by the second UE.

Certain aspects provide a first wireless communication device. The first wireless communication device includes a memory and a processor. The memory and the processor are configured to attempt to decode a first sidelink transmission received in a frequency band from a second UE. The memory and the processor are configured to transmit joint feedback comprising hybrid automatic retransmission request (HARQ) feedback regarding the first sidelink transmission and an indication of a measure of an energy level of the frequency band as measured by the first wireless communication device.

Certain aspects provide a first wireless communication device. The first wireless communication device includes a memory and a processor. The memory and the processor are configured to transmit a first sidelink transmission in a frequency band to a second UE. The memory and the processor are configured to receive joint feedback comprising hybrid automatic retransmission request (HARQ) feedback regarding the first sidelink transmission and an indication of a measure of an energy level of the frequency band as measured by the second UE.

Certain aspects provide a first wireless communication device. The first wireless communication device generally includes means for attempting to decode a first sidelink transmission received in a frequency band from a second UE. The first wireless communication device further includes means for transmitting joint feedback comprising hybrid automatic retransmission request (HARQ) feedback regarding the first sidelink transmission and an indication of a measure of an energy level of the frequency band as measured by the first wireless communication device.

Certain aspects provide a first wireless communication device. The first wireless communication device generally includes means for transmitting a first sidelink transmission in a frequency band to a second UE. The first wireless communication device further includes means for receiving joint feedback comprising hybrid automatic retransmission request (HARQ) feedback regarding the first sidelink transmission and an indication of a measure of an energy level of the frequency band as measured by the second UE.

Certain aspects provide a non-transitory computer-readable storage medium having instructions stored thereon for performing a method for wireless communication by a first wireless communication device. The method generally includes attempting to decode a first sidelink transmission received in a frequency band from a second UE. The method further includes transmitting joint feedback comprising hybrid automatic retransmission request (HARQ) feedback regarding the first sidelink transmission and an indication of a measure of an energy level of the frequency band as measured by the first wireless communication device.

Certain aspects provide a non-transitory computer-readable storage medium having instructions stored thereon for performing a method for wireless communication by a first wireless communication device. The method generally includes transmitting a first sidelink transmission in a frequency band to a second UE. The method further includes receiving joint feedback comprising hybrid automatic retransmission request (HARQ) feedback regarding the first sidelink transmission and an indication of a measure of an energy level of the frequency band as measured by the second UE.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 is a schematic diagram illustrating an example network of multiple CV2X devices operating in an unlicensed spectrum, in accordance with certain aspects of the present disclosure.

FIG. 6 is an example transmission timeline illustrating transmissions and resource reservations by a CV2X device, in accordance with certain aspects of the present disclosure.

FIG. 7 is an example transmission timeline illustrating resource selection for transmission by a CV2X device, in accordance with aspects of the present disclosure.

FIGS. 8A and 8B are example transmission timelines 700 and 750 of sidelink communications, according to certain aspects of the present disclosure.

FIGS. 9A and 9B are example transmission timelines, according to aspects of the present disclosure.

FIG. 10 is a flow diagram illustrating example operations for wireless communication by a first UE, in accordance with certain aspects of the present disclosure.

FIG. 11 is a flow diagram illustrating additional example operations for wireless communication by a first UE, in accordance with certain aspects of the present disclosure.

FIG. 12 is a flow diagram illustrating example operations for wireless communication by a second UE, in accordance with certain aspects of the present disclosure.

FIG. 13 is a flow diagram illustrating additional example operations for wireless communication by a second UE, in accordance with certain aspects of the present disclosure.

FIG. 14 illustrates a communications device that may include various components configured to perform the operations illustrated in FIGS. 10 and/or 11, in accordance with certain aspects of the present disclosure.

FIG. 15 illustrates a communications device that may include various components configured to perform the operations illustrated in FIGS. 11 and/or 12, in accordance with certain aspects of the present disclosure.

FIG. 16 shows a block diagram of a device that supports transmitting and receiving feedback, for a sidelink communication, that includes HARQ feedback and energy level feedback, in accordance with one or more aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for transmitting and receiving feedback (e.g., joint feedback), for a sidelink communication, that includes hybrid automatic retransmission request (HARQ) feedback and an indication of a measure of energy level of the sidelink transmission as received by a UE. In certain aspects, such feedback may be joint feedback, for example where the HARQ feedback and the indication are communicated together in the joint feedback. As used herein, joint feedback may refer to two or more separate indications of feedback (such as HARQ feedback and an indication of an energy level of a frequency band) included in a common message.

In certain aspects, for wireless communications in unlicensed spectrum, wireless communication devices (e.g., UEs and/or Wi-Fi devices) may perform a channel access procedure referred to as a listen-before-talk (LBT) procedure, where the devices may transmit if the channel, corresponding to a frequency band, is sensed to be free (e.g., idle) prior to transmitting. The time period prior to transmitting where the LBT procedure is performed may be referred to as a sensing occasion. In an LBT procedure, a wireless communication device measures energy on the frequency band and refrains from transmitting on the frequency band should the frequency band be busy, and determines it may communicate on the frequency band should the frequency band be idle. As used herein, the term “idle” for a frequency band means that energy as measured on the frequency band by a device determining idleness is below a threshold level. As used herein, the term “busy” for a frequency band means that energy as measured on the frequency band by the device determining idleness is above the threshold level. Such energy may be due to noise or signals within the frequency band.

According to aspects of the present disclosure, interference in unlicensed and/or shared frequency spectrum may be location-dependent. For example, when a transmitting UE detects that a channel is idle (e.g., and determines to transmit), a receiving UE (e.g., a recipient of the transmission) may be located where the channel would be detected as being busy, for example, due to there being different channel conditions (such interference from another wireless communication device) where the receiving UE is located compared to the location of the transmitting UE. Accordingly, if the transmitting UE sends a transmission to the receiving UE, the receiving UE may experience interference, such as from other devices also transmitting, when receiving the transmission and may be unable to successfully decode the transmission.

In certain aspects, the receiving UE may be configured to provide feedback to the transmitting UE regarding the transmission, such as whether or not the receiving UE was able to successfully decode the transmission. Accordingly, the transmitting UE can determine, for example, to retransmit the transmission to the receiving UE when the receiving UE indicates it was not able to successfully decode the transmission. For example, the receiving UE and transmitting UE may be configured to use a HARQ feedback mechanism.

A HARQ feedback mechanism may provide feedback information indicating whether the receiving UE successfully decoded a transmission or did not successfully decode a transmission. For example, a physical sidelink feedback channel (PSFCH) sent by a UE receiving a data transmission may indicate whether the receiving UE successfully decoded the data transmission. In an example, if a negative acknowledgment (NACK) is detected by a data-transmitting UE (e.g., one receiving UE reports a decoding failure), then the data-transmitting UE may perform a retransmission. However, in certain cases, the decoding failure reported by the receiving UE may be due to strong interference seen by the receiving UE, and so retransmitting on the same resources may not help the receiving UE to decode the retransmission. That is, if interference prevented a receiving UE from decoding a transmission and the interference is ongoing, then the ongoing interference may prevent the receiving UE from decoding the retransmission.

According to aspects of the present disclosure, a UE that attempts to receive a sidelink transmission (e.g., from a transmitting UE) in a set of transmission resources may measure an energy level in those transmission resources. The receiving UE may then report the energy level to the transmitting UE, using a feedback channel. In aspects of the present disclosure, reporting the energy level and changing scheduling in response may alleviate a hidden node problem, for example, where a device near the receiving UE is causing interference for the receiving UE but is too far from the transmitting UE for the transmitting UE to detect the interference directly.

In aspects of the present disclosure, a UE that attempts to receive a sidelink transmission may transmit joint HARQ and energy detection feedback (e.g., feedback regarding an energy level sensed by the UE) to the transmitting UE, and the transmitting UE may take steps to reduce or eliminate the impact of interference (e.g., as indicated by the energy level feedback) by altering scheduling decisions (e.g., for future sidelink transmissions to the receiving UE).

The joint feedback described herein may improve the reliability for sidelink communications, for example, due to the transmitting UE(s) taking one or more actions to avoid interference caused by the energy sensed at the receiving UE. For example, if the joint feedback indicates that energy is detected, the transmitting UE may refrain from transmitting during the resource reservation or use different resources for the sidelink transmission. The joint feedback described herein may reduce the interference encountered at the receiving UE, for example, due to the transmitting UE(s) refraining from transmitting or using different resources if the joint feedback indicates that energy is detected. As a result, techniques discussed herein may improve latency of communications, as interference avoidance may reduce the number of retransmissions that enable successful decoding of the payload.

Example sidelink communications include vehicle-to-everything (V2X) communications. Though certain aspects may be discussed with respect to V2X communications in a V2X communications system, it should be noted that the aspects may equally apply to other suitable types of sidelink communications systems. In certain aspects, such communications may occur in an unlicensed spectrum or a licensed spectrum. An unlicensed spectrum refers to any frequency band(s) that are not subject to licensed use under regulatory practice, such that the frequency band(s) are open to use by any devices, and not just devices that have a license to use the particular frequency band(s).

The following description provides examples of feedback including HARQ feedback and energy level feedback in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The electromagnetic spectrum, such as in a licensed band, is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

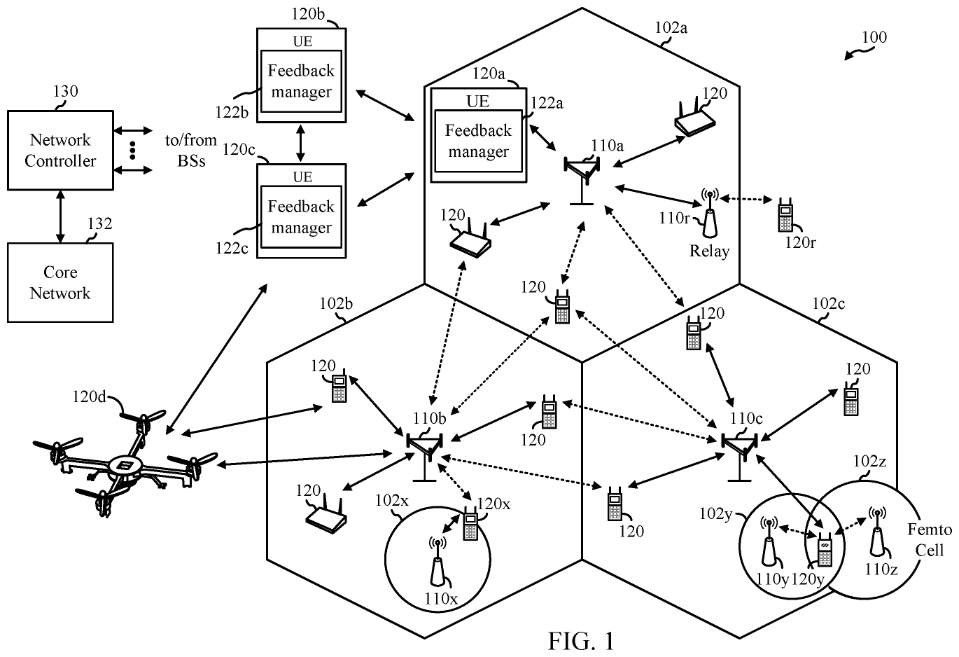

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the UEs 120 may be configured for joint HARQ and measured energy level feedback. The UE 120a includes a feedback manager 122a that receives a sidelink transmission from UE 120b in a frequency band and/or associated with a frequency band; and transmits (e.g., to the UE 120b) feedback comprising HARQ feedback regarding the sidelink transmission and an indication of a measure of energy level of the frequency band as measured by the UE 120a, in accordance with aspects of the present disclosure. Additionally or alternatively, the joint feedback manager 122a may transmit the sidelink transmission to the UE 120b; and receive the joint feedback comprising HARQ feedback regarding the sidelink transmission and an indication of a measure of energy level of the frequency band as measured by the UE 120b. Each of the UEs 120a, 120b and 120c include a similar joint feedback manager 122a, 122b and 122c, respectively.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

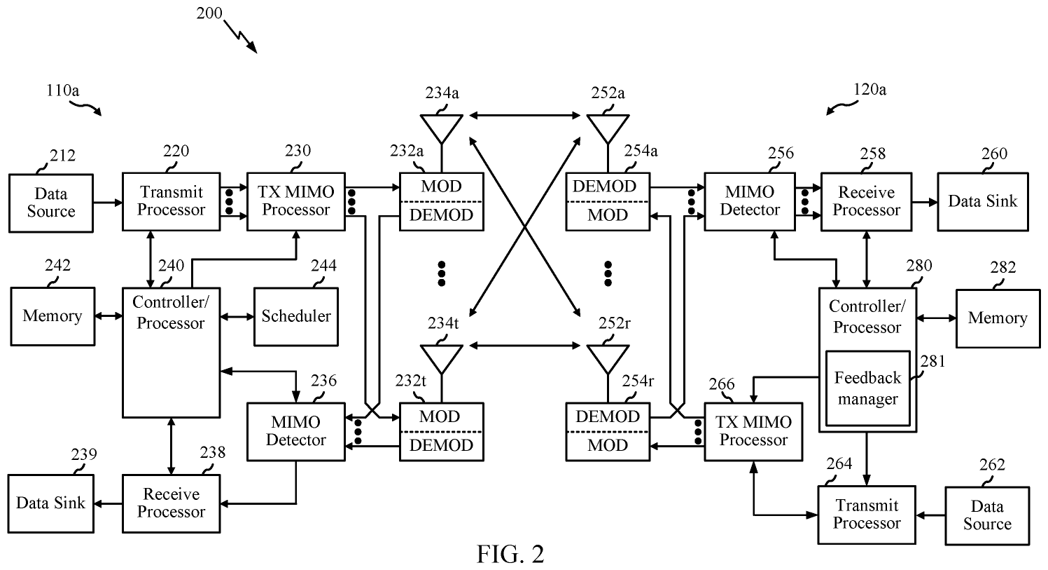

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has a joint feedback manager 281 that may be representative of the feedback manager(s) 122a, 122b, and/or 122c, according to aspects described herein. Although shown at the controller/processor, other components of the UE 120a and BS 110a may be used to perform the operations described herein.

While the UE 120a is described with respect to FIG. 2 as communicating with a BS and/or within a network, the UE 120a may be configured to communicate directly with/transmit directly to another UE 120 (e.g., UEs 120b, 120c in FIG. 1), or with/to another wireless device without relaying communications through a network. In certain aspects, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

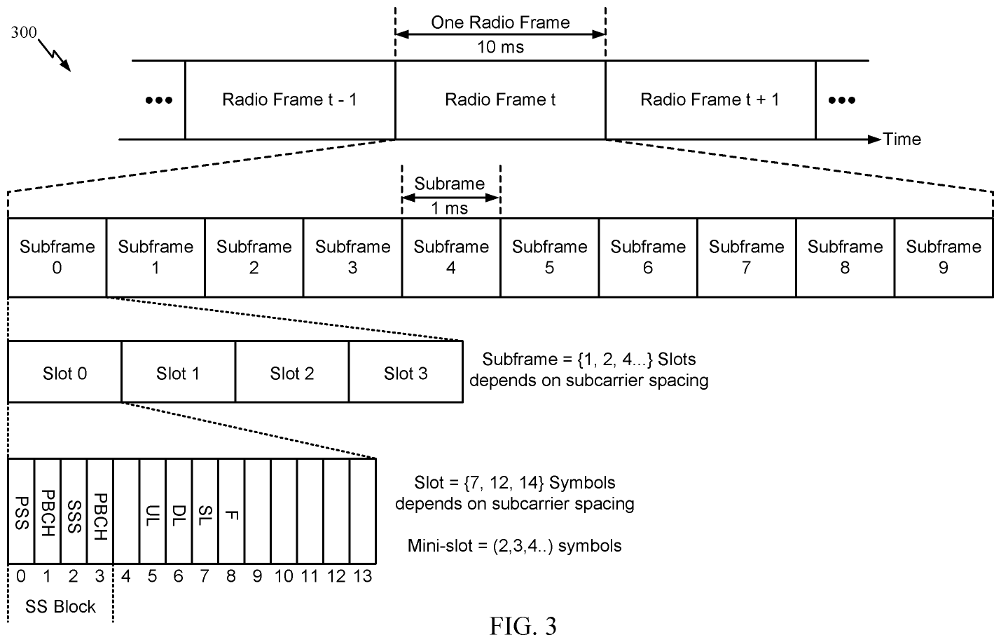

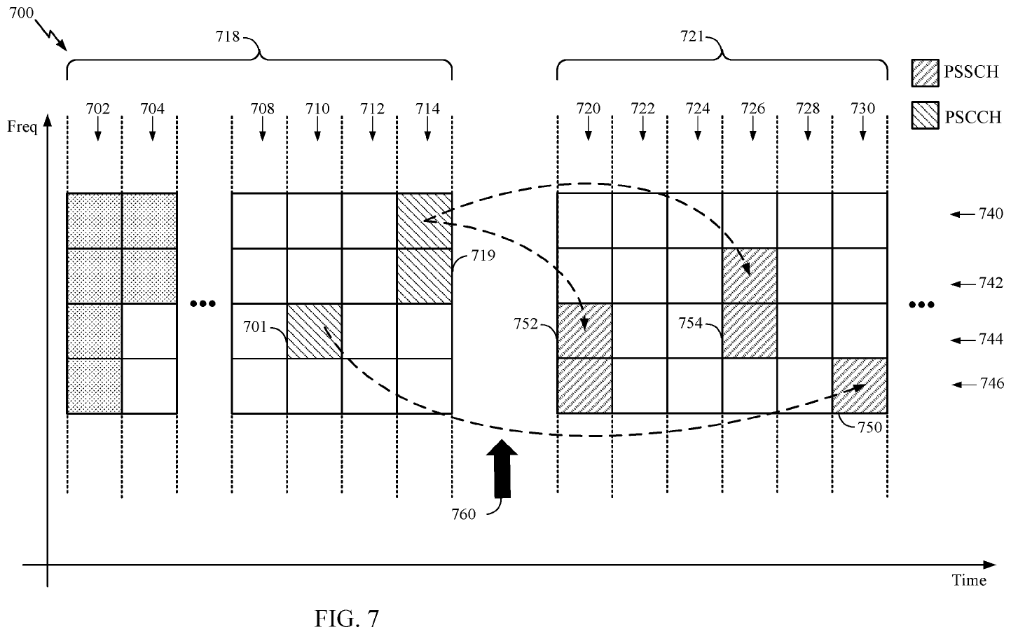

FIG. 3 is a diagram showing an example of a frame format 300 for NR. The frame format 300 described herein may be used for sidelink communications. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, sidelink (SL), or flexible (F)) for data transmission and the link direction for each subframe may be dynamically switched. The link directions may be based on a certain slot format. Each slot may include DL/UL data as well as DL/UL control information. For sidelink communications, the SL symbol(s) may be associated with candidate resources and a selection window used to schedule specific time domain resources for sidelink transmission(s), for example, based on energy levels and/or reservations detected during a sensing window as further described herein with respect to FIG. 7.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

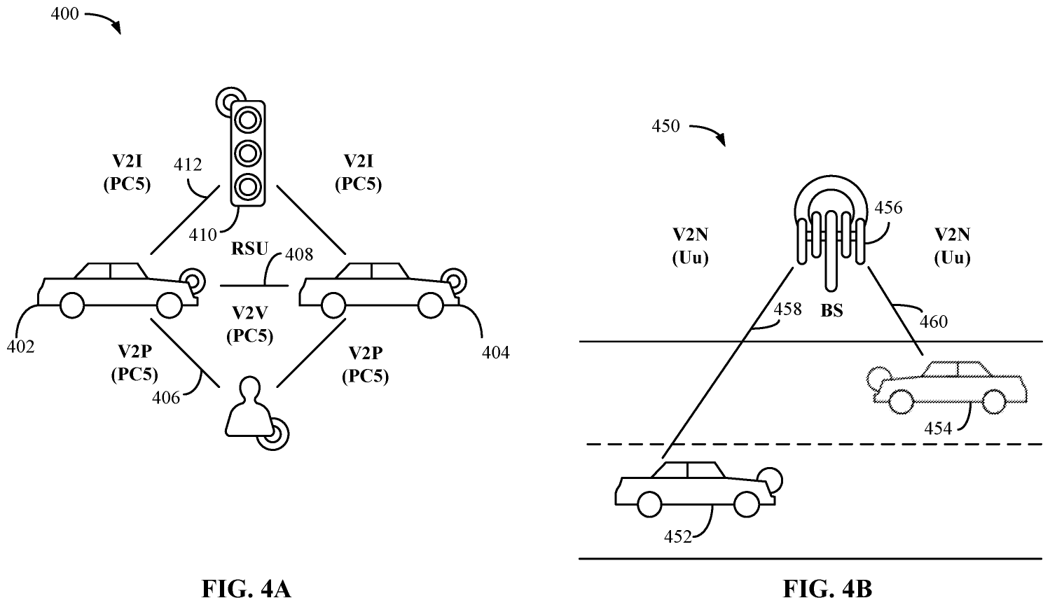

FIG. 4A and FIG. 4B show diagrammatic representations of example vehicle-to-everything (V2X) systems, in accordance with some aspects of the present disclosure. For example, the vehicles shown in FIG. 4A and FIG. 4B may communicate via sidelink channels and may relay sidelink transmissions as described herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus, in certain aspects, any vehicle with an equipped system may access a common frequency and share information.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

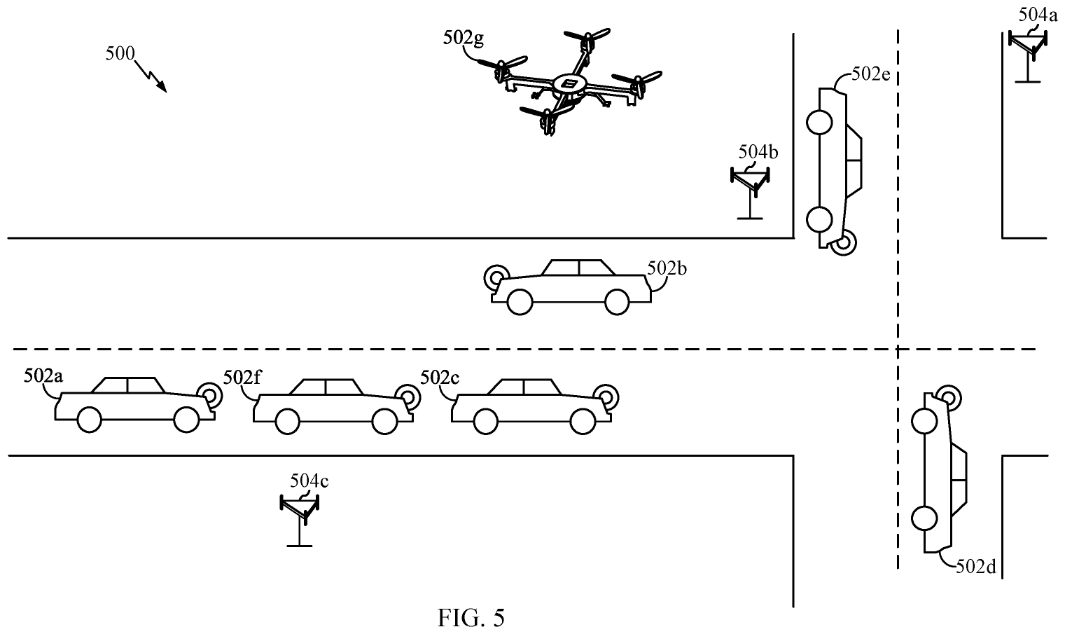

FIG. 5 is a schematic diagram illustrating an example network 500 of multiple CV2X devices operating in an unlicensed spectrum. The unlicensed spectrum may be an example of a sidelink frequency band. Further, the network 500 may be an example of a sidelink communication system. The CV2X devices 502 may be configured to communicate on sidelink frequency channels as discussed herein. For example, any of the CV2X devices 502 may communicate with any other of the CV2X devices 502.

In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)—collectively referred to as CV2X devices 502) may operate in an unlicensed spectrum with other non-CV2X devices (e.g., non-CV2X devices 504a-c—collectively referred to as non-CV2X devices 504). In some examples, the first CV2X device 502a, the sixth CV2X device 502f, and the third CV2X device 502c may be part of a fleet or platoon. In transportation, platooning or flocking is a method for driving a group of vehicles together. It is meant to increase the capacity of roads via an automated highway system. Platoons decrease the distances between cars or trucks, such as based on sidelink communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorized vehicles (such as an automobile, motorcycle, etc.) or carried by users (e.g., pedestrian, bicyclist, etc.), or implemented as a roadside unit.

According to certain aspects of the present disclosure, a UE may reserve one or more (e.g., up to two) time-frequency resources for a transmission (e.g., for retransmission of a packet).

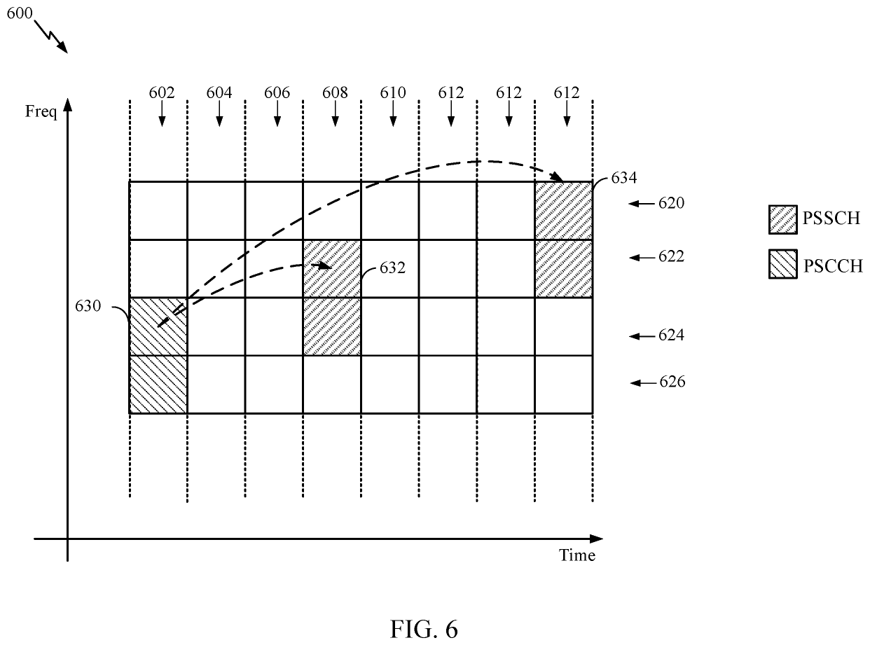

FIG. 6 is an example transmission timeline 600 illustrating transmissions and resource reservations by a CV2X device, in accordance with aspects of the present disclosure. In the example transmission timeline, a UE (e.g., UE 120a, shown in FIG. 1 and which may be a CV2X device) transmits a sidelink transmission 630 during a slot 602 on the subchannels 624 and 626. in certain aspects, the transmission includes data and control information that may be sent in a physical sidelink control channel (PSCCH), for example. The control information that the UE includes in transmission 630 reserves transmission resources on subchannels 622 and 624 during slot 608, as shown at 632. The control information in transmission 630 also reserves transmission resources on subchannels 620 and 622 during slot 612, as shown at 634. The transmission resources may be reserved for retransmissions of the data in the sidelink transmission 630, for example. Though the sidelink transmission 630 is shown on two subchannels as an example, it should be noted the sidelink transmission may occur on any suitable number of one or more subchannels. Further, the control information may reserve any suitable number of one or more resources across any suitable number of subchannels and slots. A resource, in certain aspects, is a time-frequency resource.

According to aspects of the present disclosure, channel access and resource reservation may be based on sensing of a channel (e.g., comprising one or more subchannels) by a UE with data to transmit. In an example, the UE first identifies available one or more resources for sidelink transmissions, which may be referred to as candidate resource(s). The UE then selects one or more resources, from the candidate resources, for transmission, such as for data or control information.

In certain aspects, to identify available resources, a UE monitors and decodes all transmissions on the channel. As discussed, a transmission may include control information indicating that another UE has reserved a resource. Thus, in certain aspects, the UE attempts to decode the one or more transmissions, and based on any control information in the one or more transmissions, determines resources that have been reserved. In certain aspects, the UE determines that any resources indicated as reserved in any control information are reserved resources.

In certain aspects, the UE also measures reference signal received power (RSRP) for each of the transmissions the UE attempts to decode. In certain aspects, even if a resource is indicated as reserved in the control information of a transmission, the UE only considers the resource to be a reserved resource if the transmission is received by the UE with a RSRP above a threshold. For example, should the transmission be received with a RSRP below the threshold, then the UE from which the transmission is received may be far enough from the UE receiving the transmission that it may not cause interference for both UEs to use the same resource. Conversely, in an example, should the transmission be received with a RSRP above the threshold, then the UE from which the transmission is received may be close enough from the UE receiving the transmission that it may cause interference for both UEs to use the same resource.

In certain aspects, the UE may consider other resources that are not reserved (e.g., within a time period and on the channel) as available or candidate resources for the UE to transmit a transmission. The UE may also reserve one or multiple resources of the candidate resources by transmitting control information reserving such one or more resources.

In certain aspects, when a packet arrives for transmission (e.g., arrives at a lower protocol layer from a higher protocol layer in a protocol stack of the UE), the UE determines a sensing window (e.g., a time period in the past). The UE may have received one or more transmissions during the sensing window, which may include control information. Accordingly, in certain aspects, the UE determines reserved resources as discussed based on transmissions received during the sensing window. In certain aspects, the UE then identifies available resources in a resource selection window (e.g., a time period in the future) based on any determined reserved resources. In certain aspects, by considering the RSRP of transmission in which control information is received, the UE in a sense projects measurement outcomes from the sensing window to corresponding reserved resource(s) in the selection window.

In certain aspects, to select a resource to use for a transmission, a UE may randomly select from the available resources.

FIG. 7 is an example transmission timeline 700, illustrating resource selection for transmission by a CV2X device, in accordance with aspects of the present disclosure. Though certain example numbers of transmissions, resources, and reservations are shown, one of skill in the art will understand that these are just examples, and any suitable number of transmissions, resources, and reservations may occur. The example transmission timeline includes slots 702, 704, 708, 710, 712, 714, 720, 722, 724, 726, 728, and 730, as well as subchannels 740, 742, 744, and 746. In the example transmission timeline, a UE (e.g., UE 120a, shown in FIG. 1, which may be a CV2X device) has a packet arrive for transmission at 760. The UE attempts to decode control information in transmissions received during a sensing window 718. The UE determines that control information at 701 (in slot 710 on subchannel 744) reserves transmission resources in a selection window 721 on subchannel 746 during slot 730, as shown at 750. The control information at 719 (in slot 714 on subchannels 740 and 742) reserves transmission resources on subchannels 744 and 746 during slot 720, as shown at 752, in accordance with aspects of the present disclosure. The control information at 719 may also reserve transmission resources on subchannels 742 and 744 during slot 726, as shown at 754, in accordance with aspects of the present disclosure.

In certain aspects, a sidelink communication system may use a HARQ feedback mechanism. For example, a first UE may transmit a transmission, and a second UE that received the transmission may send an acknowledgement (ACK) or a negative acknowledgement (NACK) to the first UE to indicate whether the second UE successfully decoded the transmission.

When a UE transmits data in a sidelink communication (e.g., via a physical sidelink shared channel (PSSCH)), the UE may receive HARQ feedback from other UEs receiving the sidelink communication. In an example, the HARQ feedback may be negative acknowledgment only (NACK-only) feedback, wherein a receiving UE sends a NACK when decoding of the data fails and sends nothing when decoding of the data is successful. In another example, the HARQ feedback may be ACK/NACK feedback, wherein a receiving UE sends a NACK when decoding of the data fails and sends an acknowledgment (ACK) when decoding of the data is successful.

In certain aspects, HARQ feedback transmission (e.g., in a physical sidelink feedback channel (PSFCH)) may happen in a configured or preconfigured PSFCH resource, which occurs in every N slots, for example where N may be an integer (e.g., 0, 1, 2, or 4). In an example, the resource used for HARQ feedback transmission acknowledging a PSSCH is determined (e.g., determined by the UE transmitting the HARQ feedback) based on: the time and frequency resources of the PSSCH; the transmitter UE identifier (ID); and/or the receiver UE ID, if the HARQ feedback is for ACK/NACK based groupcast communication; and the type of the feedback (e.g., ACK or NACK). In an example, each HARQ feedback is transmitted in one resource block (e.g., twelve consecutive subcarriers) and two OFDM symbols in a PSFCH slot.

In certain aspects, there may be multiple PSFCH resources configured corresponding to a PSSCH transmission. In an example, multiple resources may be used for groupcast ACK/NACK feedback, where different receiving UEs in the group may each transmit feedback in a different PSFCH resource.

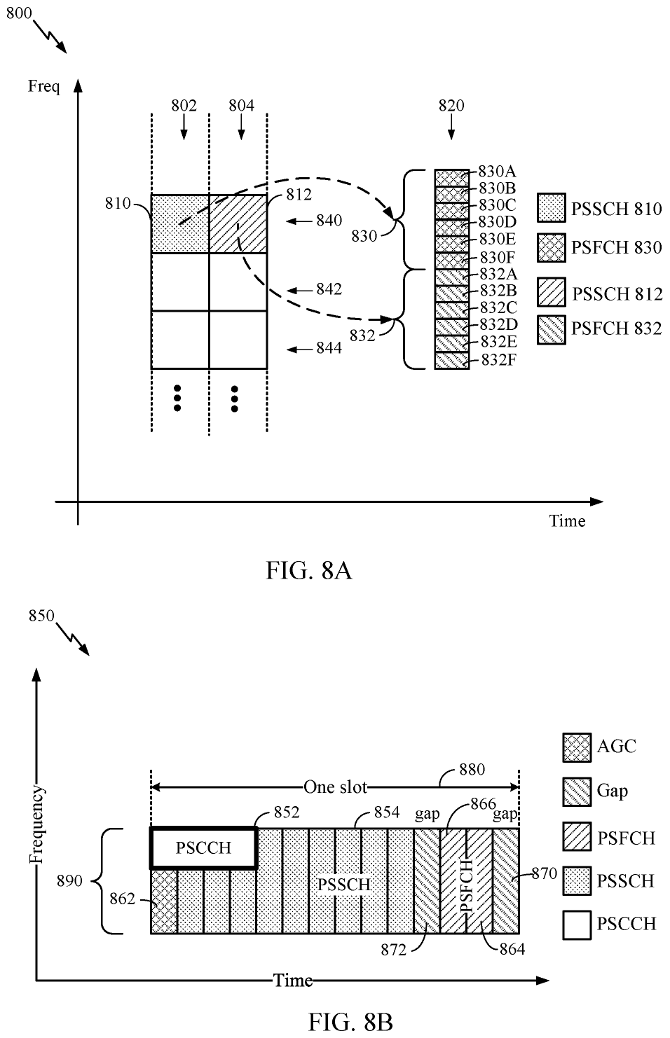

FIGS. 8A and 8B are example transmission timelines 800 and 850 of sidelink communications, according to aspects of the present disclosure. Though certain example numbers of transmissions, resources, and feedback, are shown, one of skill in the art will understand that these are just examples, and any suitable number of transmissions, resources, and reservations may occur. The example transmission timeline 800 includes slots 802 and 804, OFDM symbol 820, and subchannels 840, 842, and 844. In the transmission timeline 800, a UE (e.g., UE 120a, shown in FIG. 1) transmits data via a sidelink channel (e.g., a physical sidelink shared channel (PSSCH)) at 810 and 812. Another UE (e.g., UE 120b, shown in FIG. 1) receives the data transmissions and transmits HARQ feedback for the transmissions during OFDM symbol 820. Each of the transmissions 810 and 812 has a corresponding set of configured resources 830 or 832 for the HARQ feedback in a PSFCH resource. Each of the configured resources 830 and 832 may include six subcarriers (830A-830F, 832A-832F) during the OFDM symbol 820. The PSFCH resources may include frequency domain and code domain (e.g., cyclic shifted (CS)) resources.

Referring to FIG. 8B, in the transmission timeline 850, PSFCH resources are configured in the symbols 864 and 866 of a slot 880 on a subchannel 890. A UE (e.g., UE 120a, shown in FIG. 1) transmits a PSCCH 852 that allocates other symbols in the slot 880 for a PSSCH 854. The UE may transmit an automatic gain control (AGC) symbol in the OFDM symbol 862. Another UE, (e.g., UE 120b, shown in FIG. 1) receives the PSCCH and the PSSCH. The other UE transmits HARQ feedback regarding another PSSCH (e.g., another PSSCH transmitted two slots earlier) on a PSFCH during the symbols 864 and/or 866. Both UEs may refrain from transmitting during the final symbol 870 (e.g., a gap symbol) of the slot and during the symbol 872 (e.g., another gap symbol) before (e.g., adjacent to in time and before) the symbol 866.

In certain aspects, multiple transmitting UEs transmit data in the same resource. Accordingly, in certain aspects, multiple HARQ resources (e.g., the resources 830, 832 depicted in FIG. 8A may be an example of separate HARQ resources) may be mapped to a given transmission resource, meaning multiple different HARQ resources are available to provide feedback regarding a given transmission in the transmission resource. The multiple HARQ resources may alleviate a potential collision between HARQ transmissions by multiple UEs responding to the multiple transmissions in the resource.

As discussed, if a receiving UE experiences interference while receiving a sidelink transmission, then the receiving UE may fail to decode the sidelink transmission, causing the transmitting UE to retransmit the sidelink transmission. If the interference continues, then the receiving UE may fail to decode the retransmission.

Accordingly, it is desirable to develop techniques and apparatus for transmitting and receiving joint feedback, for a sidelink communication, that includes hybrid automatic retransmission request (HARQ) feedback and an indication of a measure of energy level of the sidelink transmission.

### Example Enhanced Feedback Transmission for Sidelink Communication in Unlicensed Spectrum

Aspects of the present disclosure provide apparatus, methods, processing systems, and computer readable mediums for transmitting and receiving joint feedback, for a sidelink communication in a frequency band, that includes hybrid automatic retransmission request (HARQ) feedback regarding the sidelink transmission and an indication of a measure of energy level in the frequency band as measured by the UE receiving the sidelink transmission.

In certain aspects of the present disclosure, a UE that attempts to receive a sidelink transmission may transmit joint HARQ and energy level feedback to the transmitting UE, and the transmitting UE may take steps to reduce or eliminate the impact of interference (e.g., as indicated by the energy level feedback) by altering scheduling decisions (e.g., for future sidelink transmissions to the receiving UE). As used herein, joint feedback may refer to two or more separate indications of feedback (such as HARQ feedback and an indication of an energy level of a channel) included in a common message.

According to certain aspects of the present disclosure, a transmitting UE that receives joint HARQ and energy level feedback may determine whether the data transmission has been successfully decoded and the energy level sensed (e.g., detected or measured) at the receiving UE. In certain aspects, the sensed energy level may be an indication of interference level experienced by the receiving UE, such as from other radio access technologies (RATs), such as Wi-Fi. In certain aspects of the present disclosure, the transmitting UE may change sidelink scheduling or adapt transmission parameters, accordingly. For example, when joint HARQ and energy level feedback indicates a NACK and a high energy level, the transmitting UE may choose to pause transmissions to the receiving UE, choose a different resource for subsequent transmissions to the receiving UE, and/or decrease MCS for subsequent transmissions to the receiving UE. In an example, if the transmitting UE pauses transmissions to the receiving UE, the transmitting UE may resume the transmissions at a later time.

According to certain aspects of the present disclosure, a UE receiving a sidelink communication (e.g., a data channel) in a frequency band may transmit joint feedback for the sidelink communication that includes HARQ feedback that indicates a decoding outcome of the sidelink communication as determined by the UE receiving the sidelink communication.

In certain aspects of the present disclosure, the joint feedback for the sidelink communication may include energy level feedback that indicates an energy level of the frequency band used for the sidelink transmission as measured by the UE.

In certain aspects of the present disclosure, a UE (e.g., UE 120a, shown in FIGS. 1-2) may transmit joint feedback in response to a transmission (e.g., a sidelink transmission) to indicate HARQ feedback (e.g., ACK or NACK) and to indicate the sensed (e.g., detected or measured) energy level in the frequency band of the transmission. Accordingly, in certain aspects, joint feedback can indicate multiple values (e.g., codepoints), and each of the values may indicate a HARQ feedback type and a sensed energy level. In an example, the joint feedback can indicate the HARQ feedback type and whether the energy measured in the frequency band is greater than an energy detection threshold (e.g., a threshold energy level); for example, the joint feedback can indicate 4 values representing 4 possible combinations of two HARQ feedback types (e.g., ACK or NACK) and two relationships to a threshold energy level (e.g., greater than a threshold energy level or less than or equal to the threshold energy level). In another example, the joint HARQ feedback may be able to indicate fewer or more values; e.g., the joint feedback may be able to indicate a relationship of the measured energy level to multiple threshold energy levels (e.g., 2 or more threshold energy levels).

In aspects of the present disclosure, a UE (e.g., UE 120a, shown in FIGS. 1-2) may transmit joint feedback (e.g., in response to a sidelink transmission) of 1 bit to indicate HARQ feedback type (e.g., ACK or NACK) and 1 bit to indicate whether the energy measured is greater than an energy detection threshold. In an example, each codepoint of 2 bits may be mapped to a specific feedback transmission time, frequency, and/or code resource. For example, a UE may convey the HARQ feedback and/or energy level by a time location of the joint feedback, frequency location of the joint feedback, and/or cyclic shift value of the joint feedback (e.g., 4 cyclic shifts for the 4 feedback types). In an example, the energy detection threshold may be configured or preconfigured (e.g., −62 dBm or −72 dBm per 20 MHz bandwidth).

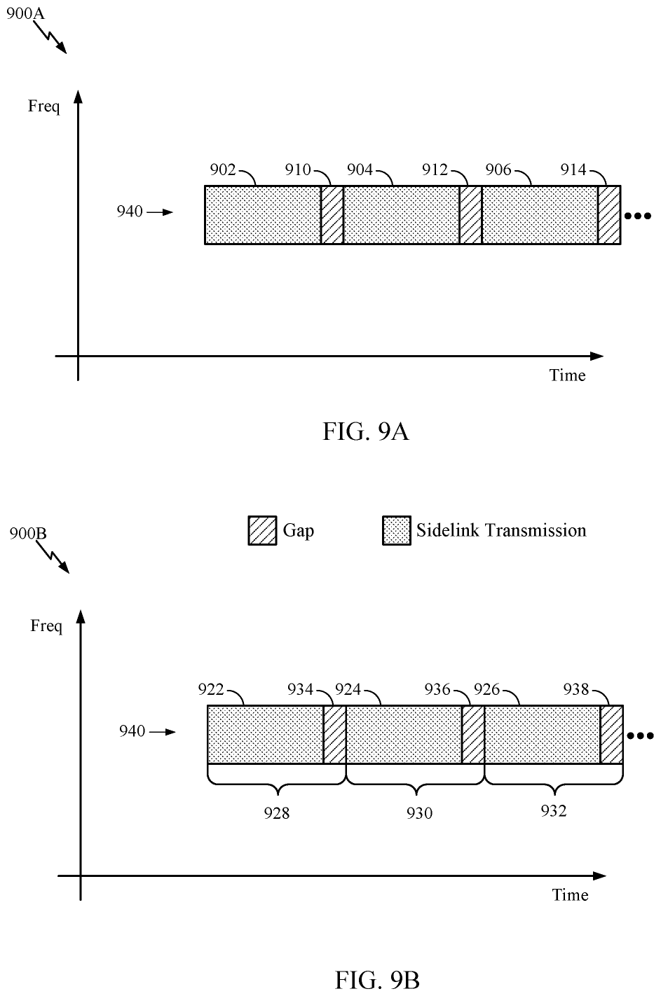

FIG. 9A is an example transmission timeline 900A, according to aspects of the present disclosure. In the example timeline, slots 902, 904, and 906; gaps 910, 912, and 924; and channel 940 for sidelink transmission are illustrated. Sidelink transmissions may be transmitted (e.g., by one or more UEs, such as UEs 120a, 120b, and 120c, shown in FIG. 1) in the slots 902, 904, and 906 in all or part of the frequency resources of the channel (e.g., sidelink transmissions may be transmitted in a slot in one or multiple subchannels in that slot). Receiving UEs may measure energy in the channel during one or more of the gaps 910, 912, and 914, which may have a pre-determined duration (e.g., 16 μs or 25 μs). In the example timeline, a UE (e.g., UE 120a) may receive a sidelink transmission in the slot 904. The UE may measure energy in the channel in either of the gaps 910 and 912, which are continuous with the slot 904.

FIG. 9B is an additional example transmission timeline 900B, according to aspects of the present disclosure. Sidelink transmissions 922, 924, 926 may be transmitted (e.g., by one or more UEs, such as UEs 120a, 120b, and 120c, shown in FIG. 1) in the slots 928, 930, and 932 in all or part of the frequency resources of the channel 940 (e.g., sidelink transmissions may be transmitted in a slot in one or multiple subchannels in that slot). Receiving UEs may measure energy in the channel during one or more of the gaps 934, 936, and 938, which may have a specific duration (e.g., 16 μs or 25 μs). In this example, the gaps 934, 936, 938 are arranged at the end of the slots 928, 930, 932, respectively, (e.g., the last symbol in the slot). In certain aspects, the gaps 934, 936, 938 may be arranged in any of the symbols in the slots 928, 930, 932, such as the first symbol. As an example, a UE (e.g., UE 120a) may receive the sidelink transmission 924 in the slot 930, and the UE may measure energy in the channel 940 in any of the gaps 934, 936, 938. The UE may transmit joint feedback as described herein in response to the sidelink transmission 924 indicating the measured energy level of the channel 940 and/or another channel (not shown).

According to certain aspects of the present disclosure, a UE (e.g., UE 120a, shown in FIGS. 1-2) may transmit joint feedback (e.g., in response to a sidelink transmission) of 2 bits that jointly indicate the HARQ feedback type and whether the energy measured is greater than the energy detection threshold, wherein the UE includes the indication of energy level only if the HARQ feedback is a NACK. For example, when a receiving UE successfully decodes a transmission, the transmitting UE may determine that any interference the receiving UE experiences is low enough (e.g., below a certain threshold RSRP) to allow for successful transmissions. In an example, a codepoint of 11 (i.e., the value of the two bits) may indicate an ACK; a codepoint of 01 may indicate a NACK and the detected energy is greater an energy level threshold (e.g., so the transmitting UE may take steps to avoid or mitigate the interference in future transmissions), and a codepoint of 10 may indicate a NACK and the detected energy is less than or equal to the threshold energy level (e.g., so the transmitting UE may attempt a retransmission in the same resource, because the feedback was a NACK).

In certain aspects of the present disclosure, a UE (e.g., UE 120a, shown in FIGS. 1-2) may transmit joint feedback (e.g., in response to a sidelink transmission) that is NACK-only feedback which also indicates the energy level; e.g., with two values (e.g., conveyed in 1 bit) indicating whether the detected energy is greater than an energy level threshold. In an example, if the UE successfully decoded the transmission and determined to convey an ACK, then the UE sends no feedback (i.e., no feedback to the data-transmitting UE indicates an ACK). In the example, if the UE fails in decoding the transmission, then the UE may send 1 bit of feedback, such as with a codepoint of 0 indicating that the detected energy is greater than an energy level threshold or such as a codepoint of 1 indicating that the detected energy is less than or equal to the energy level threshold. In the example, when the joint feedback is detected by the transmitting UE, the transmitting UE determines the receiving UE failed to decode the sidelink transmission and is able to determine whether there is high interference experienced by the receiving UE.

According to certain aspects of the present disclosure, a UE (e.g., UE 120a, shown in FIGS. 1-2) may transmit joint feedback (e.g., in response to a sidelink transmission) to indicate HARQ feedback type (e.g., ACK or NACK) and to indicate whether the energy measured is less than, greater than, or equal to a plurality of energy detection thresholds. In an example, 2 bits in the joint feedback indicate the measured energy level; each codepoint of 2 bits may be mapped to a range of energy levels, with the ranges bounded by the energy detection thresholds. In an example, a codepoint of 00 may correspond to the energy level being less than or equal to an energy detection threshold of −72 dBm, a codepoint of 01 may correspond to the energy level being greater than −72 dBm and less than or equal to an energy detection threshold of −62 dBm, a codepoint of 10 may correspond to the energy level being greater than −62 dBm and less than or equal to an energy detection threshold of −52 dBm, and a codepoint of 11 may correspond to the energy level being greater than an energy detection threshold of −52 dBm. In this example, the HARQ feedback can be ACK/NACK feedback, e.g., 1 bit in the joint feedback indicates whether the HARQ feedback is ACK or NACK; the HARQ feedback can also be NACK-only feedback, e.g., a receiving UE only sends the joint feedback when the receiving UE fails in decoding the sidelink transmission.

In certain aspects of the present disclosure, the joint feedback (e.g., in response to a sidelink transmission) may be used to convey information to the transmitting UE. For example, when a receiving UE successfully decodes a transmission, the transmitting UE may determine that any interference the receiving UE experiences is low enough to allow for successful transmissions, even without the transmitting UE receiving an explicating indication of the energy level. In an example, the joint feedback may have 3 feedback values: a first feedback value (e.g., a codepoint of 11) may indicate an ACK; a second feedback value (e.g., a codepoint of 00) may indicate a NACK and the detected energy is less than or equal to an energy level threshold of −72 dBm, a third feedback value (e.g., a codepoint of 01) may indicate a NACK and the detected energy is greater than −72 dBm and less than or equal to an energy level threshold of −62 dBm, and a fourth feedback value (e.g., codepoint of 10) may indicate a NACK and the detected energy is greater than −62 dBm.

In an example, the value (or codepoint) of a feedback may be mapped to and conveyed by a specific feedback transmission time, frequency, and/or code resource (such as in the case of code division multiplexing). For example, when a joint feedback transmission is able to convey N different values or code points (e.g., where N is an integer, such as N=4), a receiver UE can determine at least N different joint feedback resources for a sidelink transmission. In certain aspects, the joint feedback resource to be used for feedback transmission depends on the value of the feedback. In one example, joint feedback may be able to convey 3 different values (or codepoints), which are mapped to 3 cyclic shifts of a sequence. In another example, joint feedback may be able to convey 4 different values (or codepoints), which are mapped to 2 frequency locations (e.g., different PRBs) and 2 cyclic shifts.

In certain aspects of the present disclosure, a feedback (e.g., joint feedback) transmission resource may be determined (e.g., by a transmitting UE or a receiving UE) based on a feedback type (e.g., the codepoint of the feedback or the value the feedback is conveying) and/or a UE identifier (ID, e.g., a member ID of a UE in a group), such as the UE ID of the receiving UE and/or transmitting UE. As an example, a transmitting UE may distinguish feedbacks from different receiving UEs. For example, when there are M feedback types (codepoints), at least M*N_{g} feedback resources may be determined for a data channel transmission, if N_{g} (e.g., a number of UEs in a group) UEs are receiving the data channel transmission. According to certain aspects of the present disclosure, the M*N_{g} feedback resources may be frequency resources (e.g., PRBs) and/or code resources (e.g., cyclic shifts). According to certain such aspects, a receiving UE may determine a feedback (e.g., joint feedback) resource location based on the receiving UE's ID (e.g., a member ID within the group) and the feedback type.

In certain aspects of the present disclosure, feedback (e.g., joint feedback) may be transmitted only when the distance from the transmission UE to the receiving UE is smaller than a distance threshold. For example, the receiving UE is able to determine transmit-receive distance based on a transmitting UE's location and the receiving UE's own location. In certain aspects, the receiving UE may only send the joint feedback if the distance is smaller than the distance threshold.

In certain aspects of the present disclosure, measuring (e.g., by a UE) energy in the frequency band may be performed using wideband energy detection or sub-band energy detection. In one example, for measuring an energy level for use in joint feedback, a UE measures energy in the whole channel bandwidth that can be used for a sidelink communication. In another example, for measuring an energy level for use in joint feedback, a UE measures energy in part of the whole channel bandwidth that can be used for the sidelink communication; e.g., the UE measures energy in the sub-band in which the sidelink transmission has been detected.

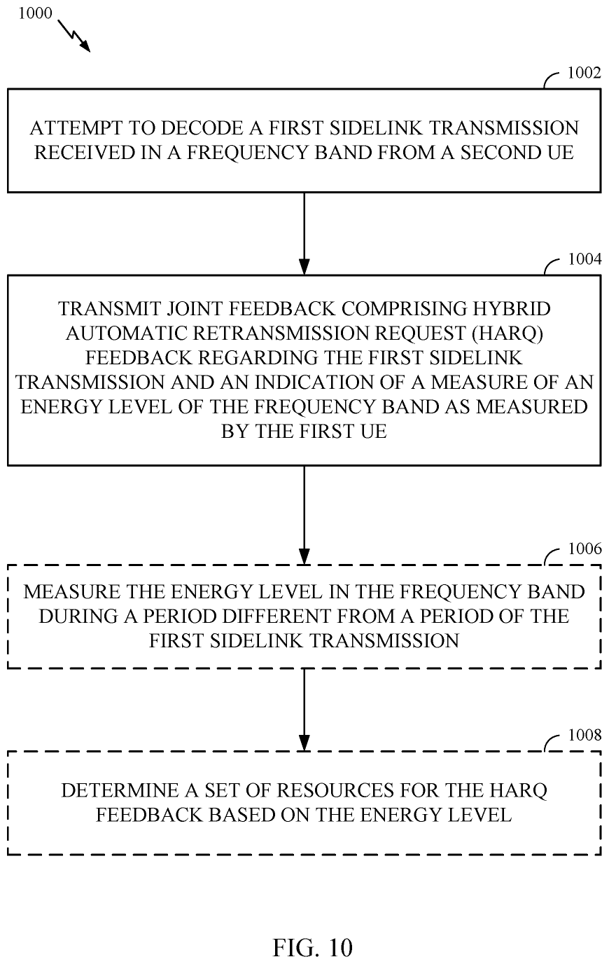

FIG. 10 is a flow diagram illustrating example operations 1000 for wireless communication, in accordance with certain aspects of the present disclosure. The operations 1000 may be performed, for example, by a first UE (e.g., the UE 120a in the wireless communication network 100). The operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1000 may begin, at block 1002, where the first UE may attempt to decode a sidelink transmission received in a frequency band from a second UE (e.g., the UE 120b). For example, the first UE may receive the sidelink transmission and attempt to decode the sidelink transmission according to the specific modulation and coding scheme (MCS) associated with the sidelink transmission, such the modulation order and/or code rate of the sidelink transmission.

Operations 1000 may continue, at block 1004, where the first UE may transmit joint feedback comprising hybrid automatic retransmission request (HARQ) feedback regarding the sidelink transmission and an indication of a measure of an energy level of the frequency band as measured by the first UE.

Operations 1000 may optionally continue, at block 1006, where the first UE may measure the energy level in the frequency band during a period different from a period of the sidelink transmission.

Operations 1000 may optionally continue, at block 1008, where the first UE may determine a set of resources for the HARQ feedback based on the energy level.

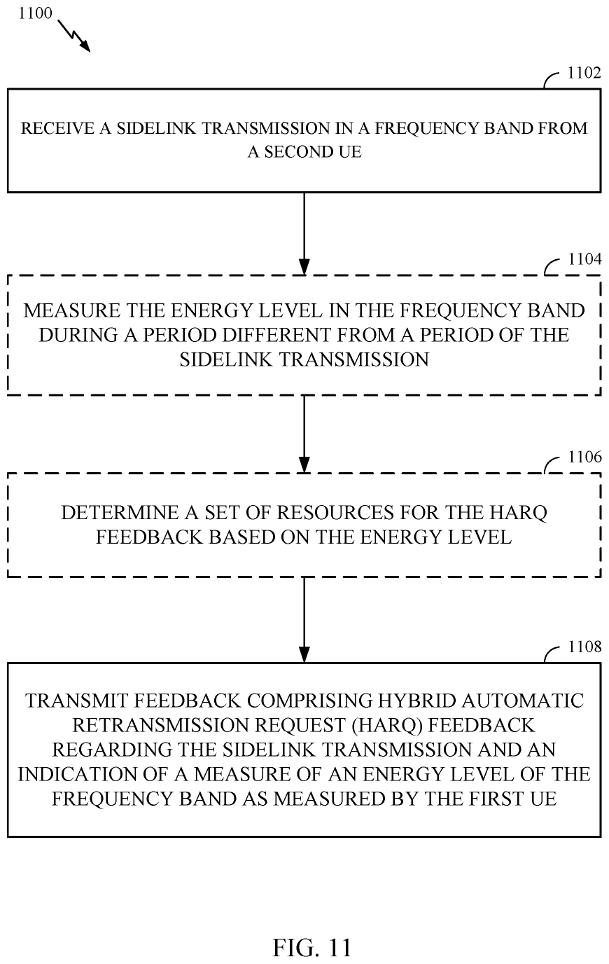

FIG. 11 is a flow diagram illustrating example operations 1100 for wireless communication, in accordance with certain aspects of the present disclosure. The operations 1100 may be performed, for example, by a first UE (e.g., the UE 120a in the wireless communication network 100). The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1100 may begin, at block 1102, where the first UE may receive a sidelink transmission in a frequency band and/or associated with the frequency band from a second UE (e.g., the UE 120b). For example, the first UE may receive a PSSCH transmission in the frequency band from the second UE. In certain cases, the first UE may receive SCI indicating a resource reservation in the frequency band that the second UE will use to transmit to the first UE. That is, a sidelink transmission associated with the frequency band may refer to a sidelink transmission that allocates resources in the frequency band.

Optionally, at block 1104, the first UE may measure the energy level in the frequency band during a period different from a period of the sidelink transmission. That is, the first UE may measure the energy level in frequency resources in which the sidelink transmission occupies during a period, where the sidelink transmission occupies the frequency resources during another period different from the period. In certain cases, the period may be continuous with the other period. For certain cases, the other period may include a portion (e.g., the portion associated with the sidelink transmission 924) of a slot (e.g., the slot 930) and the period comprises a gap (e.g., the gaps 934, 936, 938) in the slot or another slot (e.g., the slots 928 or 932). For example, the first UE may receive the sidelink transmission in a PSCCH and/or PSSCH (e.g., the PSCCH and/or PSSCH depicted in FIG. 8B), and the first UE may measure the energy level during a gap period, such as the gaps depicted in FIGS. 8B, 9A, and 9B.

Optionally, at block 1106, the first UE may determine a set of resources for the HARQ feedback based on the energy level. For example, as depicted in FIG. 8A, each of the subcarriers 830A-830F may be associated with a separate energy level, and the first UE may select one of the subcarriers 830A-830F that matches the energy level measured at block 1104.

At block 1108, the first UE may transmit feedback (e.g., joint feedback) comprising HARQ feedback regarding the sidelink transmission (such as an ACK or NACK associated with the sidelink transmission), and an indication of a measure of an energy level of the frequency band as measured by the first UE. For example, the first UE may transmit the feedback to the second UE, for example, in resources indicated for HARQ feedback as described herein with respect to FIG. 8A. The joint feedback comprising the HARQ feedback and the energy level indication may be carried in the resources 830, for example. HARQ feedback regarding the sidelink transmission may include HARQ feedback for the sidelink transmission and/or HARQ feedback for other transmission(s) scheduled in a resource reservation, which may be indicated in the sidelink transmission. That is, the first UE may receive other sidelink transmissions in a resource reservation indicated in the sidelink transmission, and the HARQ feedback may be for the other sidelink transmissions.

In certain aspects, the first UE may implicitly provide the indication of the energy level. For example, the first UE may transmit the joint feedback via specific resources reserved for indicating specific energy levels. That is, the first UE may be configured with resources associated with specific energy level(s) (e.g., the subcarriers 830A-830F), and the first UE may use at least one of the resources to provide the indication of a particular energy level to the second UE. The first UE may transmit a signal indicating the HARQ feedback in a first set of resources (e.g., the subcarriers 830A-C) when (e.g., in response to) the energy level is less than or equal to a threshold energy level. As an example, the first set of resources may be implicitly indicative of the energy level being less than or equal to a threshold energy level. The first UE may transmit another signal indicating the HARQ feedback in a second set of resources (e.g., the subcarriers 830D-F) when (e.g., in response to) the energy level is greater than (or equal to) the threshold energy level. As an example, the second set of resources may be implicitly indicative of the energy level being greater than or equal to the threshold energy level.

In certain aspects, the first UE may explicitly provide the indication of the energy level. The feedback may indicate a relationship between the energy level and a plurality of threshold energy levels. For example, the feedback may indicate that the measured energy level is between two of the threshold energy levels.

In certain cases, the feedback may consist of a single bit indicating the HARQ feedback and another single bit indicating whether the energy level is greater than a threshold energy level. That is, the feedback may consist of two bits where one of the bits is for the HARQ feedback and the other bit is for the energy level indication.

For certain cases, the joint feedback may indicate NACK-only HARQ feedback or ACK-NACK HARQ feedback. The feedback may comprise a value selected from a set of values, where the set of values include a first value that indicates the HARQ feedback comprises a NACK and the energy level is less than or equal to a first threshold energy level, and a second value that indicates the HARQ feedback comprises a NACK and the energy level is greater than the first threshold energy level. In certain aspects, the second value further indicates the energy level is less than or equal to a second threshold energy level. The set of values further comprises a third value that indicates the HARQ feedback comprises the NACK, the energy level is greater than the second threshold, and the energy level is less than or equal to a third threshold energy level. For certain aspects, the set further comprises a fourth value that indicates the HARQ feedback comprises the NACK, the energy level is greater than the third threshold energy level, and the energy level is less than or equal to a fourth threshold energy level. The set of values may provide a relationship between the measured energy level and multiple threshold energy levels. As used herein, a set may refer to a collection of one or more elements, such as a collection of values or resources.

In an ACK-NACK feedback scheme, the set of values may include a first value that indicates the HARQ feedback comprises an ACK; a second value that indicates the HARQ feedback comprises a NACK and the energy level is less than or equal to a first threshold energy level; and a third value that indicates the HARQ feedback comprises a NACK and the energy level is greater than the first threshold energy level. In the state where an ACK is indicated, the joint feedback may have a reserved field for the energy level indication, where the value of the energy level indication may be a dummy value. In certain cases, the energy level may be assumed to be a level below a specific threshold in the ACK state given that the ACK indicates the first UE successfully decoded a sidelink transmission. In certain cases, the third value further may indicate the energy level is less than or equal to a second threshold energy level. The set of values may further comprise a fourth value that indicates the HARQ feedback comprises the NACK, the energy level is greater than the second threshold energy level, and the energy level is less than or equal to a third threshold energy level. The set of values may provide a relationship between the measured energy level and multiple threshold energy levels.

In certain aspects, the first UE may transmit the joint feedback via resources based on a UE ID, such as the UE ID of the first UE and/or second UE.

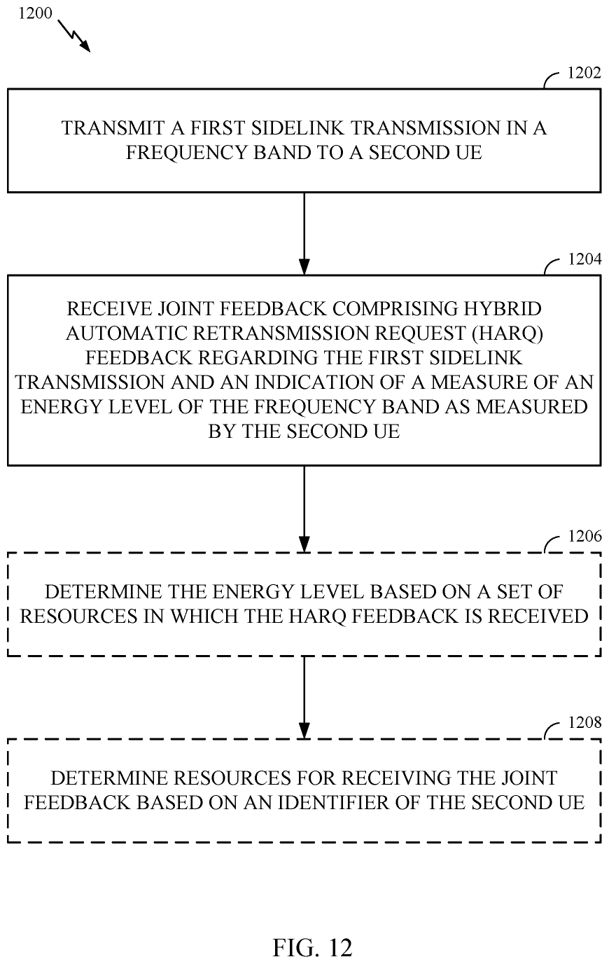

FIG. 12 is a flow diagram illustrating example operations 1200 for wireless communication, in accordance with certain aspects of the present disclosure. The operations 1200 may be performed, for example, by a second UE (e.g., the UE 120a in the wireless communication network 100). The operations 1200 may be complimentary to the operations 900 performed by the UE. The operations 1200 may be implemented as software components that are executed and run on one or more processors (e.g., controller/processor 280 of FIG. 2). Further, the transmission and reception of signals by the UE in operations 1200 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1200 may begin, at block 1202, where the second UE may transmit a first sidelink transmission in a frequency band to a first UE.

Operations 1200 may continue, at block 1204, where the second UE may receive joint feedback comprising hybrid automatic retransmission request (HARQ) feedback regarding the first sidelink transmission and an indication of a measure of an energy level of the frequency band as measured by the second UE.

Operations 1200 may optionally continue, at block 1206, where the second UE may determine the energy level based on a set of resources in which the HARQ feedback is received.

Operations 1200 may optionally continue, at block 1208, where the second UE may determine resources for receiving the joint feedback based on an identifier of the first UE and/or second UE.

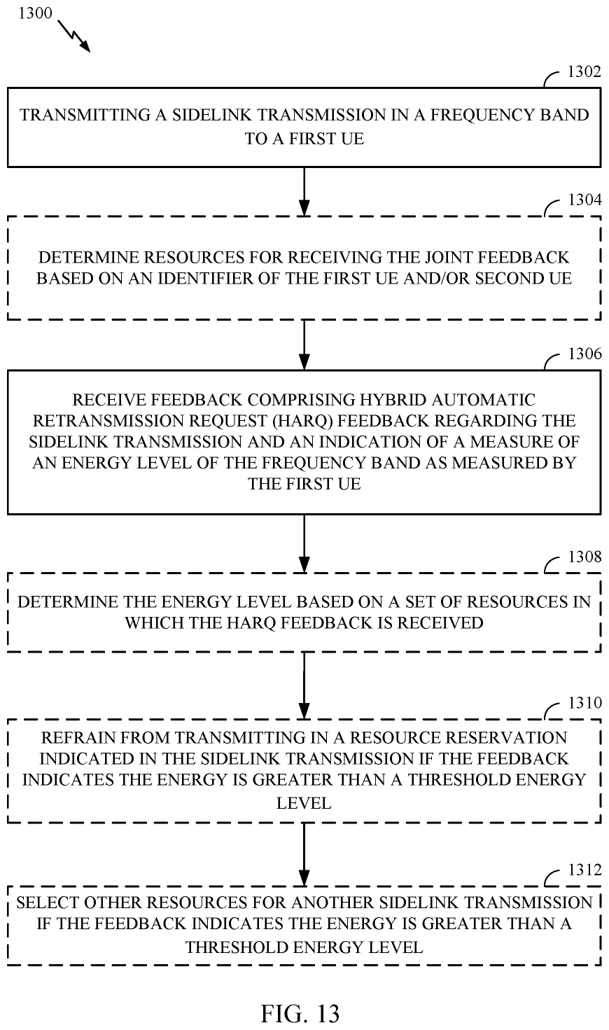

FIG. 13 is a flow diagram illustrating example operations 1300 for wireless communication, in accordance with certain aspects of the present disclosure. The operations 1300 may be performed, for example, by a second UE (e.g., the UE 120b in the wireless communication network 100). The operations 1300 may be complimentary to the operations 1100 performed by the UE. The operations 1000 may be implemented as software components that are executed and run on one or more processors (e.g., controller/processor 280 of FIG. 2). Further, the transmission and reception of signals by the UE in operations 1300 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1300 may begin, at block 1302, where the second UE may transmit a sidelink transmission in a frequency band and/or associated with the frequency band to a first UE (e.g., the UE 120a). For example, the second UE may transmit a PSSCH transmission in the frequency band to the first UE. In certain cases, the second UE may transmit SCI indicating a resource reservation in the frequency band that the second UE will use to transmit to the first UE.

Optionally, at block 1304, the second UE may determine resources for receiving the joint feedback based on an identifier of the first UE and/or second UE, for example, as described herein. As an example, the second UE may be aware that the first UE is assigned resources for feedback, such as the resources 830 depicted in FIG. 8A.

At block 1306, the second UE may receive feedback comprising HARQ feedback regarding the sidelink transmission, and an indication of a measure of an energy level of the frequency band as measured by the first UE. The second UE may receive the joint feedback via resources determined based on an identifier of the first UE and/or second UE.

Optionally, at block 1308, the second UE may determine the energy level based on a set of resources in which the HARQ feedback is received. For example, as depicted in FIG. 8A, each of the subcarriers 830A-830F may be associated with a separate energy level, and the second UE may receive the feedback in one of the subcarriers 830A-830F, which is associated with the energy level measured at the first UE.

Optionally, at block 1310, the second UE may refrain from transmitting in a resource reservation indicated in the sidelink transmission if the feedback indicates the energy is greater than a threshold energy level. For example, the sidelink transmission may include SCI that provides a resource reservation as described herein with respect to FIGS. 6 and 7. The second UE may identify that the frequency band is busy based on the energy level of the frequency band indicated in the feedback and refrain from transmitting at the transmission occasion indicated by the resource reservation.

Optionally, at block 1312, the second UE may select other resources for another sidelink transmission if the feedback indicates the energy is greater than a threshold energy level. For example, the second UE may reschedule its transmission to the first UE with different frequency resources if the feedback indicates the frequency band is busy based on the indicated energy level.

In aspects, the second UE may receive the joint feedback with an implicit or explicit indication of the energy level that is measured at the first UE, for example, as described herein with respect to the operations 1100. For example, the feedback may indicate a relationship between the energy level and a plurality of threshold energy levels in a NACK-only scheme or an ACK-NACK scheme.

It should be noted that though various blocks of operations 1000, 1100, 1200, and 1300 are specifically called out as optional blocks, in certain aspects, any blocks of operations 1000, 1100, 1200, and 1300 may be optional. Further, any suitable combination of blocks of each of operations 1000, 1100, 1200, and 1300 is within the scope of the disclosure.

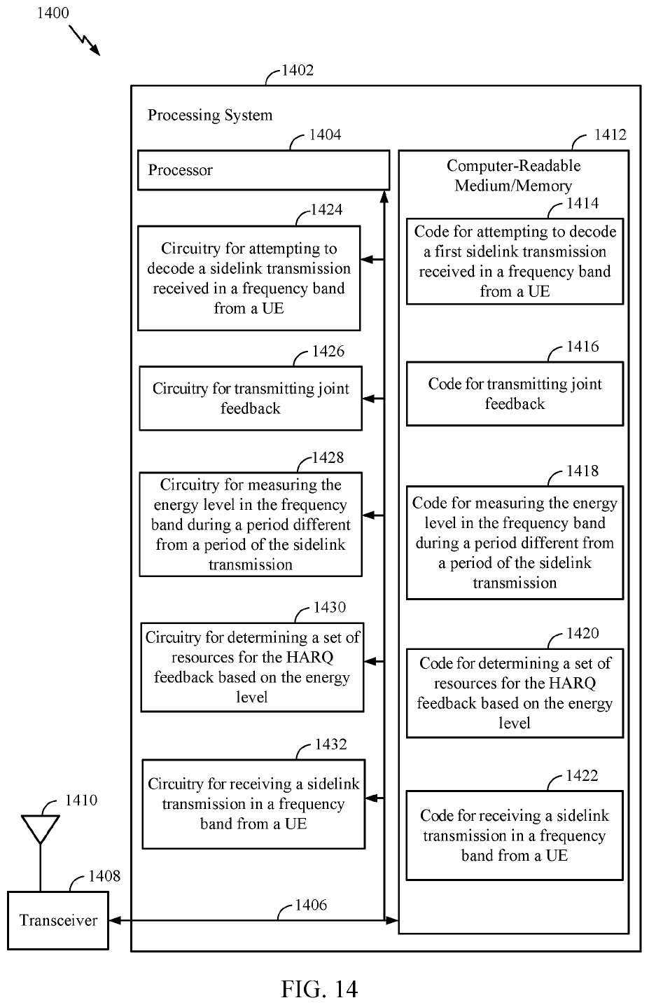

FIG. 14 illustrates a communications device 1400 that may include various components (e.g., corresponding to means-plus-function components) configured to perform operations for the techniques disclosed herein, such as the operations illustrated in FIG. 10 and/or FIG. 11. The communications device 1400 may be an example of means for performing various aspects of transmitting and receiving joint feedback, for a sidelink communication, that includes HARQ feedback and energy level feedback, as described herein. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The communications device 1400, or its sub-components, may be implemented in code (e.g., as communications management software or firmware) executed by a processor, or any combination thereof. If implemented in code executed by a processor, the functions of the communications device 1400, or its sub-components may be executed by a general-purpose processor, a digital signal processor (DSP), an application-specific integrated circuit (ASIC), a field programmable gate array (FPGA) or other programmable logic device. The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 10 and/or FIG. 11, or other operations for performing the various techniques discussed herein for transmitting and receiving joint feedback, for a sidelink communication, that includes HARQ feedback and energy level feedback. In certain aspects, computer-readable medium/memory 1412 stores code 1414 for attempting to decode a sidelink transmission received in a frequency band from a UE, code 1416 for transmitting joint feedback comprising hybrid automatic retransmission request (HARQ) feedback regarding the sidelink transmission and an indication of a measure of an energy level of the frequency band as measured by the communications device 1400, code 1418 for measuring the energy level in the frequency band during a period different from a period of the sidelink transmission, code 1420 for determining a set of resources for the HARQ feedback based on the energy level, and/or code 1422 for receiving a sidelink transmission in a frequency band from the UE.

In another implementation, the communications device 1400, or its sub-components, may be implemented in hardware (e.g., in joint feedback management circuitry). The circuitry may comprise a processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure. In certain aspects, the processor 1404 has circuitry configured to implement the code stored in the computer-readable medium/memory 1412. The processing system 1402 includes circuitry (e.g., an example of means for) 1424 for attempting to decode a sidelink transmission received in a frequency band from a UE, circuitry (e.g., an example of means for) 1426 for transmitting joint feedback comprising hybrid automatic retransmission request (HARQ) feedback regarding the sidelink transmission and an indication of a measure of an energy level of the frequency band as measured by the communications device 1400, circuitry (e.g., an example of means for) 1428 for measuring the energy level in the frequency band during a period different from a period of the sidelink transmission, circuitry (e.g., an example of means for) 1430 for determining a set of resources for the HARQ feedback based on the energy level, and/or circuitry (e.g., an example of means for) 1432 for receiving a sidelink transmission in a frequency band from the UE.

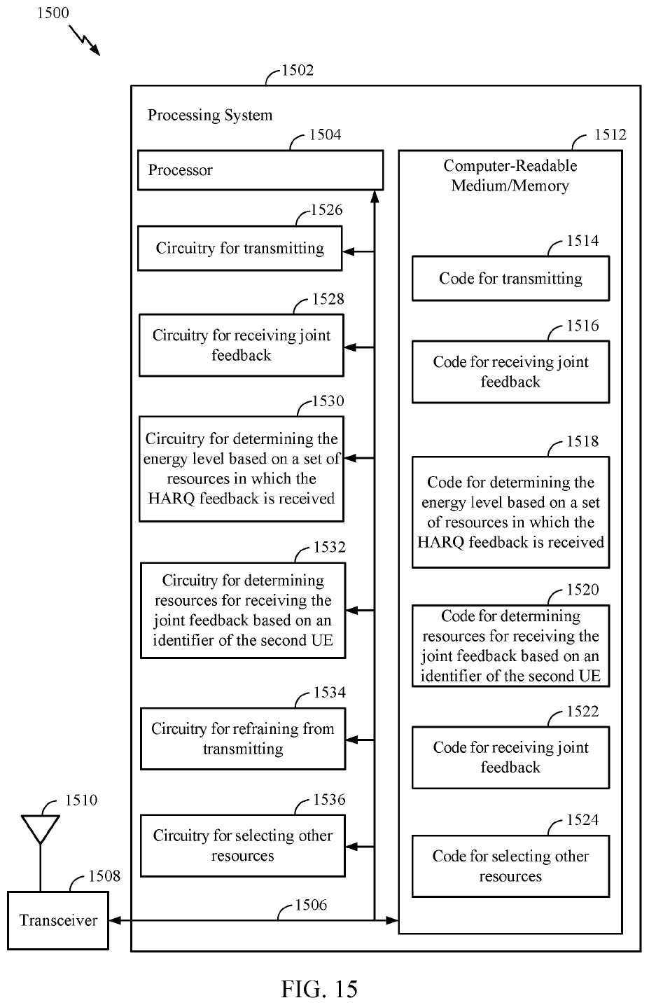

FIG. 15 illustrates a communications device 1500 that may include various components (e.g., corresponding to means-plus-function components) configured to perform operations for the techniques disclosed herein, such as the operations illustrated in FIG. 12 and/or FIG. 13. The communications device 1500 may be an example of means for performing various aspects of transmitting and receiving joint feedback, for a sidelink communication, that includes HARQ feedback and a measure of energy level, as described herein. The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The communications device 1500, or its sub-components, may be implemented in code (e.g., as communications management software or firmware) executed by a processor, or any combination thereof. If implemented in code executed by a processor, the functions of the communications device 1500, or its sub-components may be executed by a general-purpose processor, a digital signal processor (DSP), an application-specific integrated circuit (ASIC), a field programmable gate array (FPGA) or other programmable logic device. The processing system 1502 includes a processor 1504 coupled to a computer-readable medium/memory 1512 via a bus 1506. In certain aspects, the computer-readable medium/memory 1512 is configured to store instructions (e.g., computer-executable code) that when executed by the processor 1504, cause the processor 1504 to perform the operations illustrated in FIG. 12 and/or FIG. 13, or other operations for performing the various techniques discussed herein for transmitting and receiving joint feedback, for a sidelink communication, that includes HARQ feedback and a measure of energy level. In certain aspects, computer-readable medium/memory 1512 stores code 1514 for transmitting a sidelink transmission in a frequency band to a UE; code 1516 for receiving joint feedback comprising hybrid automatic retransmission request (HARQ) feedback regarding the sidelink transmission and an indication of a measure of an energy level of the frequency band as measured by the UE, code 1518 for determining the energy level based on a set of resources in which the HARQ feedback is received, code 1520 for determining resources for receiving the joint feedback based on an identifier of the UE and/or the communications device 1500, code 1522 for refraining from transmitting in a resource reservation indicated in the sidelink transmission if the feedback indicates the energy is greater than a threshold energy level (e.g., if the frequency band is busy as indicated by the energy level), and/or code 1524 for selecting other resources for another sidelink transmission if the feedback indicates the energy is greater than a threshold energy level (e.g., if the frequency band is busy as indicated by the energy level).

In another implementation, the communications device 1500, or its sub-components, may be implemented in hardware (e.g., in joint feedback management circuitry). The circuitry may comprise a processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure. In certain aspects, the processing system 1502 has circuitry configured to implement the code stored in the computer-readable medium/memory 1512. The processor 1504 includes circuitry (e.g., an example of means for) 1526 for transmitting a sidelink transmission in a frequency band to a UE, circuitry (e.g., an example of means for) 1528 for receiving joint feedback comprising hybrid automatic retransmission request (HARQ) feedback regarding the sidelink transmission and an indication of a measure of an energy level of the frequency band as measured by the first UE, circuitry (e.g., an example of means for) 15230 for determining the energy level based on a set of resources in which the HARQ feedback is received, circuitry (e.g., an example of means for) 1532 for determining resources for receiving the joint feedback based on an identifier of the UE and/or the communications device 1500, circuitry (e.g., an example of means for) 1534 for refraining from transmitting in a resource reservation indicated in the sidelink transmission if the feedback indicates the energy is greater than a threshold energy level, and/or circuitry (e.g., an example of means for) 1536 for selecting other resources for another sidelink transmission if the feedback indicates the energy is greater than a threshold energy level.

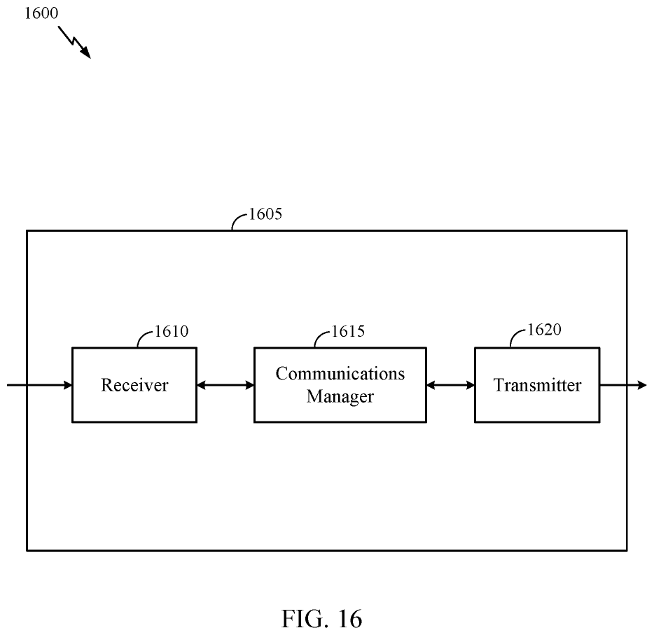

FIG. 16 shows a block diagram 1600 of a device 1605 that supports transmitting and receiving joint feedback, for a sidelink communication, that includes HARQ feedback and energy level feedback, in accordance with one or more aspects of the present disclosure. The device 1605 may be an example of aspects of a UE 120, as described herein. The device 1605 may include a receiver 1610, a communications manager 1615, and a transmitter 1620. The device 1605 may also include a processor. Each of these components may be in communication with one another (e.g., via one or more buses).

The receiver 1610 may provide a means for receiving information such as packets, user data, or control information associated with various information channels (e.g., control channels, data channels, and information related to joint feedback, for a sidelink communication, that includes HARQ feedback and a measure of energy level, etc.). Information may be passed on to other components of the device 1605. The receiver 1610 may be an example of aspects of the transceivers 1408 and 1508, described with reference to FIGS. 14 and 15. The receiver 1610 may utilize a single antenna or a set of antennas.

The communications manager 1615 may support wireless communication in accordance with examples as disclosed herein. The communications manager 1615 may provide means for attempting to decode a sidelink transmission from a UE and/or provide means for receiving the sidelink transmission from the UE. The communications manager 1615 may provide means for transmitting joint feedback comprising hybrid automatic retransmission request (HARQ) feedback regarding the sidelink transmission and an indication of a measure of energy level of the sidelink transmission as received by the UE. The communications manager 1615 may provide means for transmitting a sidelink transmission to a UE. The communications manager 1615 may provide means for receiving joint feedback comprising hybrid automatic retransmission request (HARQ) feedback regarding the sidelink transmission and an indication of a measure of energy level of the sidelink transmission as received by the UE. The communications manager 1615 may be an example of aspects of the communications devices 1400 and 1500 described herein.

The communications manager 1615 may be an example of means for performing various aspects of transmitting and receiving a sidelink transmission and/or joint feedback, for a sidelink communication, that includes HARQ feedback and a measure of energy level, as described herein. The communications manager 1615, or its sub-components, may be implemented in hardware (e.g., in communications management circuitry), code (e.g., as communications management software or firmware) executed by a processor, or any combination thereof. If implemented in code executed by a processor, the functions of the communications manager 1615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure. In some examples, the communication manager 1615 may be configured to perform various operations (e.g., receiving, determining, transmitting) using or otherwise in cooperation with the receiver 1610, the transmitter 1620, or both.

The communications manager 1615, or its sub-components, may be physically located at various positions, including being distributed such that portions of functions are implemented at different physical locations by one or more physical components. In some examples, the communications manager 1615, or its sub-components, may be a separate and distinct component in accordance with various aspects of the present disclosure. In some examples, the communications manager 1615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1620 may provide means for transmitting signals generated by other components of the device 1605. In some examples, the transmitter 1620 may be collocated with a receiver 1610 in a transceiver module. For example, the transmitter 1620 may be an example of aspects of the transceivers 1408 and 1508 described with reference to FIGS. 14 and 15. The transmitter 1620 may utilize a single antenna or a set of antennas.

### Example Aspects

In addition to the various aspects described above, specific combinations of aspects are within the scope of the disclosure, some of which are detailed below:

Aspect 1: A method of wireless communication by a first user equipment (UE), comprising: attempting to decode a first sidelink transmission received in a frequency band from a second UE; and transmitting joint feedback comprising hybrid automatic retransmission request (HARQ) feedback regarding the first sidelink transmission and an indication of a measure of an energy level of the frequency band as measured by the second UE.

Aspect 2: The method of Aspect 1, wherein the joint feedback consists of a single bit indicating the HARQ feedback and another single bit indicating whether the energy level is greater than a threshold energy level.

Aspect 3: The method of Aspects 1, wherein the joint feedback comprises a value selected from a set of values, wherein the set comprises: a first value that indicates the HARQ feedback comprises an acknowledgment (ACK); a second value that indicates the HARQ feedback comprises a negative acknowledgment (NACK) and the energy level is less than or equal to a first threshold energy level; and a third value that indicates the HARQ feedback comprises a negative acknowledgment (NACK) and the energy level is greater than the first threshold energy level.

Aspect 4: The method of Aspect 3, wherein the third value further indicates the energy level is less than or equal to a second threshold energy level.

Aspect 5: The method of Aspect 4, wherein the set further comprises a fourth value that indicates the HARQ feedback comprises the NACK, the energy level is greater than the second threshold energy level, and the energy level is less than or equal to a third threshold energy level.

Aspect 6: The method of Aspect 1, wherein the joint feedback indicates a relationship between the energy level and a plurality of threshold energy levels.

Aspect 7: The method of Aspect 1, wherein the joint feedback consists of one bit, wherein values of the one bit comprise: a first value that indicates the HARQ feedback comprises a negative acknowledgment (NACK) and the energy level is less than or equal to a threshold energy level; and a second value that indicates the HARQ feedback comprises a negative acknowledgment (NACK) and the energy level is greater than the threshold energy level.

Aspect 8: The method of Aspect 7, wherein the second value further indicates the energy level is less than or equal to a second threshold energy level; and the set further comprises: a third value that indicates the HARQ feedback comprises the NACK, the energy level is greater than the second threshold, and the energy level is less than or equal to a third threshold energy level.

Aspect 9: The method of Aspect 8, wherein the set further comprises a fourth value that indicates the HARQ feedback comprises the NACK, the energy level is greater than the third threshold energy level, and the energy level is less than or equal to a fourth threshold energy level.

Aspect 10: The method of one of Aspects 1-9, wherein the first sidelink transmission occurs during a period and the method further comprises: measuring the energy level in the frequency band during another period different from the period.

Aspect 11: The method of Aspect 10, wherein the period is continuous with the other period.

Aspect 12: The method of Aspect 10, wherein the period comprises a slot and the other period comprises a gap between the slot and another slot.

Aspect 13: The method of one of Aspects 1-12, wherein transmitting the joint feedback comprises: transmitting a signal indicating the HARQ feedback in a first set of resources when the energy level is less than or equal to a threshold energy level; and transmitting another signal indicating the HARQ feedback in a second set of resources when the energy level is greater than the threshold energy level.

Aspect 14: The method of one of Aspects 1-13, wherein transmitting the joint feedback comprises transmitting the joint feedback via resources determined based on an identifier of the first UE.

Aspect 15: A method of wireless communication by a first user equipment (UE), comprising: transmitting a first sidelink transmission in a frequency band to a second UE; and receiving joint feedback comprising hybrid automatic retransmission request (HARQ) feedback regarding the first sidelink transmission and an indication of a measure of an energy level of the frequency band as measured by the second UE.

Aspect 16: The method of Aspect 15, wherein the joint feedback consists of a single bit indicating the HARQ feedback and another single bit indicating whether the energy level is greater than a threshold energy level.

Aspect 17: The method of Aspect 15, wherein the joint feedback comprises a value selected from a set of values, wherein the set comprises: a first value that indicates the HARQ feedback comprises an acknowledgment (ACK); a second value that indicates the HARQ feedback comprises a negative acknowledgment (NACK) and the energy level is less than or equal to a first threshold energy level; and a third value that indicates the HARQ feedback comprises a negative acknowledgment (NACK) and the energy level is greater than the first threshold energy level.

Aspect 18: The method of Aspect 17, wherein the third value further indicates the energy level is less than or equal to a second threshold energy level.

Aspect 19: The method of Aspect 18, wherein the set further comprises a fourth value that indicates the HARQ feedback comprises the NACK, the energy level is greater than the second threshold energy level, and the energy level is less than or equal to a third threshold energy level.

Aspect 20: The method of Aspect 15, wherein the joint feedback indicates a relationship between the energy level and a plurality of threshold energy levels.

Aspect 21: The method of Aspect 15, wherein the joint feedback comprises a value selected from a set of values, wherein the set comprises: a first value that indicates the HARQ feedback comprises a negative acknowledgment (NACK) and the energy level is less than or equal to a first threshold energy level; and a second value that indicates the HARQ feedback comprises a negative acknowledgment (NACK) and the energy level is greater than the first threshold energy level.

Aspect 22: The method of Aspect 21, wherein the second value further indicates the energy level is less than or equal to a second threshold energy level; and the set further comprises: a third value that indicates the HARQ feedback comprises the NACK, the energy level is greater than the second threshold energy level, and the energy level is less than or equal to a third threshold energy level.

Aspect 23: The method of Aspect 22, wherein the set further comprises a fourth value that indicates the HARQ feedback comprises the NACK, the energy level is greater than the third threshold energy level, and the energy level is less than or equal to a fourth threshold energy level.

Aspect 24: The method of one of Aspects 15-23, wherein first sidelink transmission is transmitted during a period and the energy level is measured in the frequency band during another period different from the period.

Aspect 25: The method of Aspect 24, wherein the period is continuous with the other period.

Aspect 26: The method of Aspect 24, wherein the period comprises a slot and the other period comprises a gap between the slot and another slot.

Aspect 27: The method of one of Aspects 15-26, wherein receiving the joint feedback comprises: receiving a signal indicating the HARQ feedback in a first set of resources when the energy level is less than or equal to a threshold energy level; and receiving another signal indicating the HARQ feedback in a second set of resources when the energy level is greater than the threshold energy level.

Aspect 28: The method of one of Aspects 15-27, wherein receiving the joint feedback comprises receiving the joint feedback via resources determined based on an identifier of the second UE.

Aspect 29: An apparatus for wireless communications, comprising means for performing one or more of the methods of Aspects 1-28 or 52-61.

Aspect 30: An apparatus for wireless communications, comprising: a memory; and a processor coupled to the memory, the memory and the processor configured to perform the method of one or more of Aspects 1-28 or 52-61.

Aspect 31: A computer-readable medium, the medium including instructions that, when executed by a processing system, cause the processing system to perform the method of one or more of Aspects 1-28 or 52-61.

Aspect 32: An apparatus for wireless communications, comprising: a memory; and a processor coupled to the memory, the processor and the memory being configured to: receive a sidelink transmission in a frequency band from a user equipment, transmit feedback comprising: hybrid automatic retransmission request (HARQ) feedback regarding the sidelink transmission, and an indication of a measure of an energy level of the frequency band as measured by the apparatus.

Aspect 33: The apparatus of Aspect 32, wherein the feedback consists of a single bit indicating the HARQ feedback and another single bit indicating whether the energy level is greater than a threshold energy level.

Aspect 34: The apparatus of Aspect 32, wherein the feedback comprises a value selected from a set of values, wherein the set of values comprises: a first value that indicates the HARQ feedback comprises a negative acknowledgment (NACK) and the energy level is less than or equal to a first threshold energy level; and a second value that indicates the HARQ feedback comprises a NACK and the energy level is greater than the first threshold energy level.

Aspect 35: The apparatus of Aspect 34, wherein the second value further indicates the energy level is less than or equal to a second threshold energy level and the set further comprises: a third value that indicates the HARQ feedback comprises the NACK, the energy level is greater than the second threshold, and the energy level is less than or equal to a third threshold energy level.

Aspect 36: The apparatus of Aspect 32, wherein the feedback comprises a value selected from a set of values, wherein the set of values comprises: a first value that indicates the HARQ feedback comprises an acknowledgment (ACK); a second value that indicates the HARQ feedback comprises a NACK and the energy level is less than or equal to a first threshold energy level; and a third value that indicates the HARQ feedback comprises a NACK and the energy level is greater than the first threshold energy level.

Aspect 37: The apparatus of Aspect 36, wherein the third value further indicates the energy level is less than or equal to a second threshold energy level.

Aspect 38: The apparatus according to any one of Aspects 35 or 37, wherein the set further comprises a fourth value that indicates the HARQ feedback comprises the NACK, the energy level is greater than the second threshold energy level, and the energy level is less than or equal to a third threshold energy level.

Aspect 39: The apparatus according to any one of Aspects 32-38, wherein the feedback indicates a relationship between the energy level and a plurality of threshold energy levels.

Aspect 40: The apparatus according to any of Aspects 32-39, wherein the processor and the memory are configured to measure the energy level in frequency resources in which the sidelink transmission occupies during a period, wherein the sidelink transmission occupies the frequency resources during another period different from the period.

Aspect 41: The apparatus of Aspect 40, wherein the period is continuous with the other period.

Aspect 42: The apparatus of Aspect 40, wherein the other period comprises a portion of a slot and the period comprises a gap in the slot or another slot.

Aspect 43: The apparatus according to any one of Aspects 32-42, wherein the processor and the memory are configured to: transmit a signal indicating the HARQ feedback in a first set of resources indicative of the energy level being less than or equal to a threshold energy level; and transmit another signal indicating the HARQ feedback in a second set of resources indicative of the energy level being greater than the threshold energy level.

Aspect 44: An apparatus for wireless communications, comprising: a memory; and a processor coupled to the memory, the processor and the memory being configured to: transmit a sidelink transmission in a frequency band to a user equipment, and receive feedback comprising: hybrid automatic retransmission request (HARQ) feedback regarding the sidelink transmission, and an indication of a measure of an energy level of the frequency band as measured by the user equipment.

Aspect 45: The apparatus of Aspect 44, wherein the feedback consists of a single bit indicating the HARQ feedback and another single bit indicating whether the energy level is greater than a threshold energy level.

Aspect 46: The apparatus of Aspect 44, wherein the feedback comprises a value selected from a set of values, wherein the set of values comprises: a first value that indicates the HARQ feedback comprises a negative acknowledgment (NACK) and the energy level is less than or equal to a first threshold energy level; and a second value that indicates the HARQ feedback comprises a NACK and the energy level is greater than the first threshold energy level.

Aspect 47: The apparatus of Aspect 44, wherein the feedback comprises a value selected from a set of values, wherein the set of values comprises: a first value that indicates the HARQ feedback comprises an acknowledgment (ACK); a second value that indicates the HARQ feedback comprises a NACK and the energy level is less than or equal to a first threshold energy level; and a third value that indicates the HARQ feedback comprises a NACK and the energy level is greater than the first threshold energy level.

Aspect 48: The apparatus according to any one of Aspects 44-47, wherein the feedback indicates a relationship between the energy level and a plurality of threshold energy levels.

Aspect 49: The apparatus according to any one of Aspects 44-48, wherein the processor and the memory are configured to: receive a signal indicating the HARQ feedback in a first set of resources indicative of the energy level being less than or equal to a threshold energy level; and receive another signal indicating the HARQ feedback in a second set of resources indicative of the energy level being greater than the threshold energy level.

Aspect 50: The apparatus according to any one of Aspects 44-49, wherein the processor and the memory are configured to refrain from transmitting in a resource reservation indicated in the sidelink transmission if the feedback indicates the energy level is greater than a threshold energy level.

Aspect 51: The apparatus according to any one of Aspects 44-50, wherein the memory and the processor are configured to select other resources for another sidelink transmission if the feedback indicates the energy level is greater than a threshold energy level.

Aspect 52: A method for wireless communications by a first user equipment (UE), comprising: receiving a sidelink transmission in a frequency band from a second UE; and transmitting feedback comprising: hybrid automatic retransmission request (HARQ) feedback regarding the sidelink transmission, and an indication of a measure of an energy level of the frequency band as measured by the first UE.

Aspect 53: The method of Aspect 52, wherein the feedback consists of a single bit indicating the HARQ feedback and another single bit indicating whether the energy level is greater than a threshold energy level.

Aspect 54: The method of Aspect 52, wherein the feedback comprises a value selected from a set of values, wherein the set of values comprises: a first value that indicates the HARQ feedback comprises a negative acknowledgment (NACK) and the energy level is less than or equal to a first threshold energy level; and a second value that indicates the HARQ feedback comprises a NACK and the energy level is greater than the first threshold energy level.

Aspect 55: The method according to any one of Aspects 52-54, wherein the feedback indicates a relationship between the energy level and a plurality of threshold energy levels.

Aspect 56: A method for wireless communications by a second user equipment (UE), comprising: transmitting a sidelink transmission in a frequency band to a first UE; and receiving feedback comprising: hybrid automatic retransmission request (HARQ) feedback regarding the sidelink transmission, and an indication of a measure of an energy level of the frequency band as measured by the second UE.

Aspect 57: The method of Aspect 56, wherein the feedback consists of a single bit indicating the HARQ feedback and another single bit indicating whether the energy level is greater than a threshold energy level.

Aspect 58: The method of Aspect 56, wherein the feedback comprises a value selected from a set of values, wherein the set of values comprises: a first value that indicates the HARQ feedback comprises a negative acknowledgment (NACK) and the energy level is less than or equal to a first threshold energy level; and a second value that indicates the HARQ feedback comprises a NACK and the energy level is greater than the first threshold energy level.

Aspect 59: The method according to any one of Aspects 56-58, wherein the feedback indicates a relationship between the energy level and a plurality of threshold energy levels.

Aspect 60: The method according to any one of Aspects 56-59, further comprising refraining from transmitting in resource reservation indicated in the sidelink transmission if the feedback indicates the energy level is greater than a threshold energy level.

Aspect 61: The method according to any one of Aspects 56-60, further comprising selecting other resources for another sidelink transmission if the feedback indicates the energy level is greater than a threshold energy level.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 10, FIG. 10, FIG. 11, FIG. 12, and/or FIG. 13.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a memory; and
a processor coupled to the memory, the processor and the memory being configured to:
receive a sidelink transmission in a frequency band from a user equipment, and
transmit feedback comprising:
hybrid automatic retransmission request (HARQ) feedback regarding the sidelink transmission, and
an indication of a measure of an energy level of the frequency band as measured by the apparatus.

2. The apparatus of claim 1, wherein the feedback consists of a single bit indicating the HARQ feedback and another single bit indicating whether the energy level is greater than a threshold energy level.

3. The apparatus of claim 1, wherein the feedback comprises a value selected from a set of values, wherein the set of values comprises:
a first value that indicates the HARQ feedback comprises a negative acknowledgment (NACK) and the energy level is less than or equal to a first threshold energy level; and
a second value that indicates the HARQ feedback comprises a NACK and the energy level is greater than the first threshold energy level.

4. The apparatus of claim 3, wherein the second value further indicates the energy level is less than or equal to a second threshold energy level and the set of values further comprises:
a third value that indicates the HARQ feedback comprises the NACK, the energy level is greater than the second threshold, and the energy level is less than or equal to a third threshold energy level.

5. The apparatus of claim 1, wherein the feedback comprises a value selected from a set of values, wherein the set of values comprises:
a first value that indicates the HARQ feedback comprises an acknowledgment (ACK);
a second value that indicates the HARQ feedback comprises a NACK and the energy level is less than or equal to a first threshold energy level; and
a third value that indicates the HARQ feedback comprises a NACK and the energy level is greater than the first threshold energy level.

6. The apparatus of claim 5, wherein the third value further indicates the energy level is less than or equal to a second threshold energy level.

7. The apparatus of claim 6, wherein the set of values further comprises a fourth value that indicates the HARQ feedback comprises the NACK, the energy level is greater than the second threshold energy level, and the energy level is less than or equal to a third threshold energy level.

8. The apparatus of claim 1, wherein the feedback indicates a relationship between the energy level and a plurality of threshold energy levels.

9. The apparatus of claim 1, wherein the processor and the memory are configured to measure the energy level in frequency resources in which the sidelink transmission occupies during a period, wherein the sidelink transmission occupies the frequency resources during another period different from the period.

10. The apparatus of claim 9, wherein the period is continuous with the other period.

11. The apparatus of claim 9, wherein the other period comprises a portion of a slot and the period comprises a gap in the slot or another slot.

12. The apparatus of claim 1, wherein the processor and the memory are configured to:
transmit a signal indicating the HARQ feedback in a first set of resources indicative of the energy level being less than or equal to a threshold energy level; and
transmit another signal indicating the HARQ feedback in a second set of resources indicative of the energy level being greater than the threshold energy level.

13. An apparatus for wireless communications, comprising:
a memory; and
a processor coupled to the memory, the processor and the memory being configured to:
transmit a sidelink transmission in a frequency band to a user equipment, and
receive feedback comprising:
hybrid automatic retransmission request (HARQ) feedback regarding the sidelink transmission, and
an indication of a measure of an energy level of the frequency band as measured by the user equipment.

14. The apparatus of claim 13, wherein the feedback consists of a single bit indicating the HARQ feedback and another single bit indicating whether the energy level is greater than a threshold energy level.

15. The apparatus of claim 13, wherein the feedback comprises a value selected from a set of values, wherein the set of values comprises:
a first value that indicates the HARQ feedback comprises a negative acknowledgment (NACK) and the energy level is less than or equal to a first threshold energy level; and
a second value that indicates the HARQ feedback comprises a NACK and the energy level is greater than the first threshold energy level.

16. The apparatus of claim 13, wherein the feedback comprises a value selected from a set of values, wherein the set of values comprises:
a first value that indicates the HARQ feedback comprises an acknowledgment (ACK);
a second value that indicates the HARQ feedback comprises a NACK and the energy level is less than or equal to a first threshold energy level; and
a third value that indicates the HARQ feedback comprises a NACK and the energy level is greater than the first threshold energy level.

17. The apparatus of claim 13, wherein the feedback indicates a relationship between the energy level and a plurality of threshold energy levels.

18. The apparatus of claim 13, wherein the processor and the memory are configured to:
receive a signal indicating the HARQ feedback in a first set of resources indicative of the energy level being less than or equal to a threshold energy level; and
receive another signal indicating the HARQ feedback in a second set of resources indicative of the energy level being greater than the threshold energy level.

19. The apparatus of claim 13, wherein the processor and the memory are configured to refrain from transmitting in a resource reservation indicated in the sidelink transmission if the feedback indicates the energy level is greater than a threshold energy level.

20. The apparatus of claim 13, wherein the memory and the processor are configured to select other resources for another sidelink transmission if the feedback indicates the energy level is greater than a threshold energy level.

21. A method for wireless communications by a first user equipment (UE), comprising:
receiving a sidelink transmission in a frequency band from a second UE; and
transmitting feedback comprising:
hybrid automatic retransmission request (HARQ) feedback regarding the sidelink transmission, and
an indication of a measure of an energy level of the frequency band as measured by the first UE.

22. The method of claim 21, wherein the feedback consists of a single bit indicating the HARQ feedback and another single bit indicating whether the energy level is greater than a threshold energy level.

23. The method of claim 21, wherein the feedback comprises a value selected from a set of values, wherein the set of values comprises:
a first value that indicates the HARQ feedback comprises a negative acknowledgment (NACK) and the energy level is less than or equal to a first threshold energy level; and
a second value that indicates the HARQ feedback comprises a NACK and the energy level is greater than the first threshold energy level.

24. The method of claim 21, wherein the feedback indicates a relationship between the energy level and a plurality of threshold energy levels.

25. A method for wireless communications by a second user equipment (UE), comprising:
transmitting a sidelink transmission in a frequency band to a first UE; and
receiving feedback comprising:
hybrid automatic retransmission request (HARQ) feedback regarding the sidelink transmission, and
an indication of a measure of an energy level of the frequency band as measured by the second UE.

26. The method of claim 25, wherein the feedback consists of a single bit indicating the HARQ feedback and another single bit indicating whether the energy level is greater than a threshold energy level.

27. The method of claim 25, wherein the feedback comprises a value selected from a set of values, wherein the set of values comprises:
a first value that indicates the HARQ feedback comprises a negative acknowledgment (NACK) and the energy level is less than or equal to a first threshold energy level; and
a second value that indicates the HARQ feedback comprises a NACK and the energy level is greater than the first threshold energy level.

28. The method of claim 25, wherein the feedback indicates a relationship between the energy level and a plurality of threshold energy levels.

29. The method of claim 25, further comprising refraining from transmitting in a resource reservation indicated in the sidelink transmission if the feedback indicates the energy level is greater than a threshold energy level.

30. The method of claim 25, further comprising selecting other resources for another sidelink transmission if the feedback indicates the energy level is greater than a threshold energy level.
